(19) United States
(12) Patent Application Publication
(10) Pub. No.: US 2024/0181692 A1
(43) Pub. Date: Jun. 6, 2024

(54) METHOD FOR PRODUCING RESIN FILM

(71) Applicant: GUNZE LIMITED, Kyoto (JP)

(72) Inventors: Jun TAKAICHI, Shiga (JP); Nobuhiro WATANABE, Shiga (JP); Tatsuya KIBAYASHI, Shiga (JP); Kensuke KAMEI, Shiga (JP)

(73) Assignee: GUNZE LIMITED, Kyoto (JP)

(21) Appl. No.: 18/285,678

(22) PCT Filed: Apr. 7, 2022
(86) PCT No.: PCT/JP2022/017248

§ 371 Date: Oct. 5, 2023

(30) Foreign Application Priority Data
Apr. 9, 2021 (JP) 2021-066610
Apr. 27, 2021 (JP) 2021-074933
Apr. 30, 2021 (JP) 2021-077565
Jul. 27, 2021 (JP) 2021-122777
Sep. 10, 2021 (JP) 2021-147823

(51) Int. Cl. B29C 48/00; B29B 17/00; B29B 17/02; B29B 17/04; B29C 48/08; B29K 105/26; B32B 27/08; B32B 27/20; B32B 27/30; B32B 27/32

(52) U.S. Cl. CPC B29C 48/0021; B29B 17/02; B29B 17/0412; B29C 48/08; B32B 27/08; B32B 27/20; B32B 27/302; B32B 27/325; B29B 2017/0015; B29B 2017/0234; B29K 2105/26; B32B 2250/246; B32B 2250/40; B32B 2264/025; B32B 2270/00; B32B 2272/00; B32B 2307/406; B32B 2307/414; B32B 2307/54; B32B 2307/736; B32B 2307/748; B32B 2519/00

(57) ABSTRACT

This method for producing a resin film includes the following: preparing, as a starting material, at least either a film label that includes an ink layer and a resin layer or a resin bottle to which the film label is fitted; recovering a thermoplastic resin having a specific gravity of less than 1 from the starting material; and obtaining a resin film having a specific gravity of less than 1 by extrusion molding, while having a molding material contain the recovered thermoplastic resin, wherein the recovering includes the following: dividing the starting material or the resin layer into individual pieces; removing the ink layer from the film label or each piece of the film label; and subjecting the starting material, the resin layer or pieces of the starting material or the resin layer to specific gravity separation.

### TECHNICAL FIELD

The present disclosure relates to a method for producing a resin film.

### BACKGROUND ART

Patent Document 1 discloses a technique for obtaining high purity pellets in the case of recycling and pelletizing a plastic bottle to which a label is attached. More specifically, a thermoplastic polymer label from which an ink layer is easily removed, a method for removing an ink on a thermoplastic polymer label, a method for recycling a label from which an ink has been removed and a bottle, and the like are disclosed. The label disclosed in Patent Document 1 can easily remove the ink layer laminated on the label by immersing the label in alkaline hot water. The thermoplastic resin of the label from which the ink layer has been removed is separated and selected for each specific gravity, and is used for preparation of recycled pellets.

In addition, Patent Document 2 discloses a laminated film in which an ink layer can be separated by being immersed in water. This laminated film includes a resin layer containing polyvinyl alcohol between a resin film and a printing layer printed with ink. According to Patent Document 2, when this laminated film is immersed in water, a monolayer film and the ink of each layer are separated in water, so that each separated product can be selected and recovered for each specific gravity.

As described above, removing the ink layer from the label using the thermoplastic resin enables more accurate specific gravity separation of the thermoplastic resin. Some printing inks contain a component having a relatively large specific gravity, for example, like titanium oxide. A label on which such a layer of ink is laminated may be separated as one having a large specific gravity regardless of the type of thermoplastic resin, and may have an undesirable effect on the purity of the recycled pellet. By using the techniques disclosed in Patent Documents 1 and 2, it is expected that a plastic bottle including a label is actively reused.

As the resin film, for example, resin films as disclosed in Patent Documents 3 to 5 have been known.

### PRIOR ART DOCUMENTS

### Patent Documents

Patent Document 1: Japanese Patent Laid-Open Publication No. H11-333952
Patent Document 2: PCT International Publication No. 2021/090690
Patent Document 3: Japanese Patent Laid-Open Publication No. 2017-071064
Patent Document 4: Japanese Patent No. 5617059
Patent Document 5: Japanese Patent Laid-Open Publication No. 2004-276516

### SUMMARY OF THE INVENTION

### Problems to be Solved by the Invention

Among the thermoplastic resins separated and recovered from the label and the bottle, for example, a resin having a specific gravity of more than 1 such as polyester is recycled as a label and a bottle after recovery, and circulation from resources to products is repeated. However, for a thermoplastic resin having a specific gravity of less than 1, such circulation has not yet been considered, and the thermoplastic resin tends to be discarded after being separated and recovered.

An object of the present disclosure is to provide a method for producing a resin film having a specific gravity of less than 1 by recovering a thermoplastic resin having a specific gravity of less than 1 from at least one of a film label having an ink layer and a resin layer and a resin bottle to which the film label is attached, and using the recovered thermoplastic resin.

### Means for Solving the Problem

A method for producing a resin film according to a first aspect of the present disclosure includes the following steps:
preparing at least one of a film label having an ink layer and a resin layer, and a resin bottle to which the film label is attached as a starting material: recovering a thermoplastic resin having a specific gravity of less than 1 from the starting material: and extrusion molding a resin film having a specific gravity of less than 1 including the recovered thermoplastic resin in the raw material. Further, the recovering a thermoplastic resin having a specific gravity of less than 1 includes the following steps: cutting the starting material or the resin layer into pieces: separating the ink layer from the film label or pieces of the film label to obtain the resin layer or pieces of the resin layer from which the ink layer has been removed: and subjecting the starting material, the resin layer, or the pieces thereof to specific gravity separation, and recovering the starting material, the resin layer, or the pieces thereof having a specific gravity of less than 1.

A method for producing a resin film according to a second aspect of the present disclosure is the method for producing a resin film according to the first aspect, in which the recovering a thermoplastic resin having a specific gravity of less than 1 includes cutting the starting material into pieces: separating the ink layer from pieces of the film label to obtain pieces of the resin layer from which the ink layer has been removed: and subjecting the pieces of the resin layer to specific gravity separation, and recovering the pieces of the resin layer having a specific gravity of less than 1 in this order.

A method for producing a resin film according to a third aspect of the present disclosure is the method for producing a resin film according to the first aspect or the second aspect, further including laminating an ink layer on the extrusion molded resin film to prepare a film label having an ink layer and a resin layer.

A method for producing a resin film according to a fourth aspect of the present disclosure is the method for producing a resin film according to any one of the first to third aspects, in which the method further repeats one or more times recovery of a thermoplastic resin having a specific gravity of less than 1 using the prepared film label as the starting material, and preparation of a resin film having a specific gravity of less than 1 including the recovered thermoplastic resin in the raw material.

A method for producing a resin film according to a fifth aspect of the present disclosure is the method for producing a resin film according to any one of the first to fourth aspects, in which the obtaining the resin layer or the pieces of the resin layer from which the ink layer has been removed includes immersing the film label or the pieces of the film label in an alkaline aqueous solution to separate the ink layer.

A method for producing a resin film according to a sixth aspect of the present disclosure is the method for producing a resin film according to any one of the first to fifth aspects, further including neutralizing the resin layer or the pieces of the resin layer after being immersed in the alkaline aqueous solution.

A method for producing a resin film according to a seventh aspect of the present disclosure is the method for producing a resin film according to any one of the first to sixth aspects, in which the obtaining the resin layer or the pieces of the resin layer from which the ink layer has been removed includes immersing the film label or the pieces of the film label in water to separate the ink layer.

A method for producing a resin film according to an eighth aspect of the present disclosure is the method for producing a resin film according to any one of the first to seventh aspects, in which the obtaining the resin layer or the pieces of the resin layer from which the ink layer has been removed includes washing the resin layer or the pieces of the resin layer after the ink layer is separated.

A method for producing a resin film according to a ninth aspect of the present disclosure is the method for producing a resin film according to any one of the first to eighth aspects, further including drying the recovered thermoplastic resin having a specific gravity of less than 1 between the recovering a thermoplastic resin having a specific gravity of less than 1 and the extrusion molding a resin film having a specific gravity of less than 1.

A resin film according to a tenth aspect of the present disclosure is a heat shrinkable film, and includes a surface layer composed of a cyclic olefin-based resin, an ethylene-based resin, and a petroleum resin. The surface layer contains the ethylene-based resin in an amount of 35% by mass or less and in an amount of 5% by mass or more of the petroleum resin, with respect to 100% by mass of the total of the cyclic olefin-based resin, the ethylene-based resin, and the petroleum resin.

Patent Document 3 discloses a heat shrinkable multilayer film having front and back layers and an intermediate layer. The front and back layers contain a cyclic olefin-based resin in an amount of 60 to 80% by weight and an ethylene-based resin in an amount of 20 to 40% by weight. The intermediate layer contains a resin, and contains a propylene component in an amount of 35 to 70 mol %, an ethylene component in an amount of 1 to 10 mol %, and a butene component in an amount of 1 to 10 mol %, based on 100 mol % of the total of the resin components constituting the intermediate layer. According to Patent Document 3, this configuration provides a heat shrinkable film having low density, excellent shrinkage and high rigidity, hardly causing delamination, and having excellent transparency.

In Patent Document 3, a heat shrinkable film having a haze value of less than 7.0% is defined as an acceptable range. The haze value is an index indicating the degree of haze of a heat shrinkable film, and the lower the haze value, the higher the transparency. However, in some cases, it is required to satisfy higher transparency standards and to improve other appearance qualities. Other criteria for evaluating appearance quality include, for example, grease resistance. When a fat component adheres to a heat shrinkable film due to contact with a human hand before heat shrinkage or the like, whitening may occur at the portion after heat shrinkage. Grease resistance represents the degree of suppression of whitening due to the fat component, and higher grease resistance is preferable.

The tenth aspect of the present disclosure provides a heat shrinkable film further improved in transparency and grease resistance.

A resin film according to an eleventh aspect of the present disclosure is the resin film according to the tenth aspect, and further includes a core layer laminated adjacent to the surface layer. The core layer contains a propylene-based resin and a petroleum resin.

A resin film according to a twelfth aspect of the present disclosure is the resin film according to the tenth or eleventh aspect, in which the core layer contains a petroleum resin in an amount of 10% by mass or more, with respect to 100% by mass of the total of the propylene-based resin and the petroleum resin.

A resin film according to a thirteenth aspect of the present disclosure is the resin film according to any one of the tenth to twelfth aspects, in which the core layer further contains a cyclic olefin-based resin and an ethylene-based resin.

A resin film according to a fourteenth aspect of the present disclosure is the resin film according to any one of the tenth to thirteenth aspects, in which the core layer contains long-chain branched polypropylene as the propylene-based resin.

A resin film according to a fifteenth aspect of the present disclosure is the resin film according to any one of the tenth to fourteenth aspects, in which the surface layer is laminated adjacent to both surfaces of the core layer.

A resin film according to a sixteenth aspect of the present disclosure is the resin film according to any one of the tenth to fifteenth aspects, in which the cyclic olefin-based resin includes a first cyclic olefin-based resin with a glass transition temperature of Tg1 (° C.) and a second cyclic olefin-based resin with a glass transition temperature of Tg2 (° C.), and the difference between the glass transition temperatures Tg1 and Tg2 is 10° C. or more.

A resin film according to a seventeenth aspect of the present disclosure is the resin film according to any one of the tenth to sixteenth aspects, in which the glass transition temperatures Tg1 and Tg2 satisfy Tg1>70° C. and Tg2≤ 70° C.

A resin film according to an eighteenth aspect of the present disclosure is the resin film according to any one of the tenth to seventeenth aspects, in which the petroleum resin includes an alicyclic petroleum resin.

A resin film according to a nineteenth aspect of the present disclosure is a heat shrinkable multilayer film, and includes a core layer and a surface layer. The core layer has a first surface and a second surface and contains a thermoplastic resin. The surface layer is laminated on at least one of the first surface and the second surface of the core layer, and contains a thermoplastic resin and fine particles held by the thermoplastic resin. The modal diameter of the fine particles is 1.2 times or more and 10 times or less the thickness of the thermoplastic resin contained in the surface layer.

Patent Document 4 discloses a heat shrinkable multilayer film obtained by laminating front and back layers containing a cyclic olefin-based resin and organic fine particles, and an intermediate layer. According to Patent Document 4, the front and back layers contain organic fine particles with an average particle diameter of 0.1 μm or more and 20 μm or less in an amount of 0.01% by weight or more and 0.3% by weight or less. This prevents blocking of the heat shrinkable multilayer film.

In Patent Document 4, a preferable content and average particle diameter of the organic fine particles are defined, but a dimensional relationship between the resin of the front and back layers and the organic fine particles is not considered. Therefore, even if the front and back layers are heat shrinkable multilayer films containing fine particles as described above, anti-blocking effect by the fine particles is not sufficiently exhibited, and blocking may still occur.

A nineteenth aspect of the present disclosure provides a heat shrinkable multilayer film with improved anti-blocking function.

A resin film according to a twentieth aspect of the present disclosure is the resin film according to the nineteenth aspect, in which the modal diameter of the fine particles is 2 times or more and 8 times or less the thickness of the thermoplastic resin contained in the surface layer.

A resin film according to a twenty-first aspect of the present disclosure is the resin film according to the nineteenth or twentieth aspect, in which the modal diameter of the fine particles is 6 μm or less.

A resin film according to a twenty-second aspect of the present disclosure is the resin film according to any one of the nineteenth to twenty-first aspects, in which the thermoplastic resin contained in the surface layer includes a cyclic olefin-based resin.

A resin film according to a twenty-third aspect of the present disclosure is the resin film according to any one of the nineteenth to twenty-second aspects, and further includes an adjacent layer laminated on at least one of the first surface and the second surface of the core layer and containing a thermoplastic resin. The surface layer is laminated on the adjacent layer.

A resin film according to a twenty-fourth aspect of the present disclosure is the resin film according to any one of the nineteenth to twenty-third aspects, in which an adjacent layer is laminated on each of the first surface and the second surface of the core layer, and a surface layer is laminated on each of the adjacent layers.

A resin film according to a twenty-fifth aspect of the present disclosure is the resin film according to any one of the nineteenth to twenty-fourth aspects, in which the thermoplastic resin contained in the adjacent layer includes a cyclic olefin-based resin.

A resin film according to a twenty-sixth aspect of the present disclosure is a heat shrinkable multilayer film, and includes a core layer and an adjacent layer. The core layer has a first surface and a second surface. The adjacent layer is laminated on at least one of the first surface and the second surface of the core layer and contains a thermoplastic resin. The core layer contains long-chain branched polypropylene in an amount of 3% by mass or more and less than 20% by mass.

Patent Document 5 discloses a heat shrinkable multilayer film. The heat shrinkable multilayer film disclosed in Patent Document 5 is formed by laminating an outermost layer containing a resin (A) having an alicyclic structure in a molecule and having a thickness of 1 μm or less and an intermediate layer containing a thermoplastic resin (B) other than the (A). According to Patent Document 5, this provides a heat shrinkable multilayer film having small natural shrinkage during storage and a large shrinkage during heating.

Such a heat shrinkable multilayer film is also used as a shrink label or a packaging material attached to a plastic or metal container by using its heat shrinkability. Therefore, in addition to the sufficient shrinkage during heating, the fact that loosening is less likely to occur after heat shrinkage is also required as its performance. However, Patent Document 5 does not consider this point.

A twenty-sixth aspect of the present disclosure provides a heat shrinkable multilayer film that is less likely to loosen after heat shrinkage.

A resin film according to a twenty-seventh aspect of the present disclosure is the resin film according to the twenty-sixth aspect, in which the core layer contains an alicyclic petroleum resin in an amount of more than 20% by mass.

A resin film according to a twenty-eighth aspect of the present disclosure is the resin film according to the twenty-sixth or twenty-seventh aspect, in which the adjacent layer contains a cyclic olefin-based resin.

A resin film according to a twenty-ninth aspect of the present disclosure is the resin film according to any one of the twenty-sixth to twenty-eighth aspects, in which the core layer has a thickness of 10 μm to 60 μm.

A resin film according to a thirtieth aspect of the present disclosure is the resin film according to any one of the twenty-sixth to twenty-ninth aspects, and further includes a surface layer laminated on the adjacent layer and containing a thermoplastic resin.

A resin film according to a thirty-first aspect of the present disclosure is the resin film according to any one of the twenty-sixth to thirtieth aspects, in which an adjacent layer is laminated on each of the first surface and the second surface of the substrate, and a surface layer is laminated on each of the adjacent layers.

A resin film according to a thirty-second aspect of the present disclosure is a heat shrinkable multilayer film, and includes a core layer, an adjacent layer, and a surface layer. The core layer has a first surface and a second surface and contains a thermoplastic resin. The adjacent layer is laminated on at least one of the first surface and the second surface of the core layer. The surface layer is laminated on the adjacent layer and contains a thermoplastic resin. The adjacent layer contains a cyclic olefin-based resin in an amount of 50% by mass or more and 90% by mass or less and a petroleum resin in an amount of 5% by mass or more and 35% by mass or less. The thickness of the surface layer is 10% or less of the thickness of the resin constituting the entire heat shrinkable multilayer film.

Patent Document 5 discloses a heat shrinkable multilayer film. The heat shrinkable multilayer film disclosed in Patent Document 5 is formed by laminating an outermost layer containing a resin (A) having an alicyclic structure in a molecule and having a thickness of 1 μm or less and an intermediate layer containing a thermoplastic resin (B) other than the (A). Examples of the thermoplastic resin (B) include petroleum resins and the like. According to Patent Document 5, this provides a heat shrinkable multilayer film having a large shrinkage during heating and excellent sebum whitening properties.

According to Patent Document 5, the layer made of the thermoplastic resin (B) preferably contains the thermoplastic resin (B) in an amount of 70% by weight or more and 100% by weight or less of all resin components constituting the layer. However, when the petroleum resin is contained in the above-mentioned range, toughness and rigidity as a heat shrinkable multilayer film may be deteriorated. This point is not considered in Patent Document 5.

A thirty-second aspect of the present disclosure provides a heat shrinkable multilayer film having higher resistance to sebum whitening while maintaining rigidity.

A resin film according to a thirty-third aspect of the present disclosure is the resin film according to the thirty-second aspect, in which the adjacent layer further contains an ethylene-based resin in an amount of 30% by mass or less.

A resin film according to a thirty-fourth aspect of the present disclosure is the resin film according to the thirty-second or thirty-third aspect, in which the surface layer contains a cyclic olefin-based resin.

A resin film according to a thirty-fifth aspect of the present disclosure is the resin film according to any one of the thirty-second to thirty-fourth aspects, in which the adjacent layer contains a petroleum resin in an amount of 10% by mass or more and 30% by mass or less.

A resin film according to a thirty-sixth aspect of the present disclosure is the resin film according to any one of the thirty-second to thirty-fifth aspects, in which an adjacent layer is laminated on each of the first surface and the second surface of the core layer, and a surface layer is laminated on each of the adjacent layers.

The resin films according to the tenth to thirty-sixth aspects may be included in at least one of the resin layers in the starting materials of the production methods according to the first to ninth aspects and the resin films extruded in the production methods according to the first to ninth aspects.

A heat shrinkable label according to a thirty-seventh aspect of the present disclosure includes the resin film according to any one of the tenth to thirty-sixth aspects.

The heat shrinkable label according to the thirty-seventh aspect may be included in the film labels in the starting materials of the production methods according to the first to ninth aspects.

### Advantages of the Invention

According to the above aspects, there is provided a method for producing a resin film having a specific gravity of less than 1 by recovering a thermoplastic resin having a specific gravity of less than 1 from at least one of a film label having an ink layer and a resin layer and a resin bottle to which the film label is attached, and using the recovered thermoplastic resin. The resin film to be produced can be used again as a film label having an ink layer. This makes it possible to form circulation of the thermoplastic resin having a specific gravity of less than 1 contained in the film label or the resin bottle.

### BRIEF DESCRIPTION OF THE DRAWINGS

FIG. 1 is a flowchart showing a flow of a production method according to a first embodiment.

FIG. 2 is a flowchart showing a flow of a production method according to a second embodiment.

FIG. 3 is a flowchart showing a flow of a production method according to a third embodiment.

FIG. 4 is a cross-sectional view showing an example of an olefin film.

FIG. 5A is a cross-sectional view showing an example of an olefin film.

FIG. 5B is a cross-sectional view showing an example of an olefin film.

FIG. 5C is a cross-sectional view showing an example of an olefin film.

FIG. 6A is a cross-sectional view showing an example of an olefin film.

FIG. 6B is a cross-sectional view showing an example of an olefin film.

### EMBODIMENTS OF THE INVENTION

Hereinafter, some embodiments of the method for producing a resin film according to the present disclosure will be described. In this production method, a thermoplastic resin having a specific gravity of less than 1 is recovered from a film label or a resin bottle containing the film label, and a resin film having a specific gravity of less than 1 is produced using the recovered thermoplastic resin. The resin bottle is typically a PET bottle mainly composed of polyethylene terephthalate (PET). The resin film to be produced is suitable for a base film of a film label to be attached to a resin bottle, and can be reused as a film label of a resin bottle containing a PET bottle by being subjected to processing such as printing. That is, according to this production method, it is possible to cyclically produce a film label as a recycled product from a film label as a starting material. A film label as a starting material, a resin film (resin layer) contained in the film label, and a resin film and a film label produced by this production method are also included in the scope of the present disclosure. Configurations of these resin films and film labels will be described later.

### First Embodiment

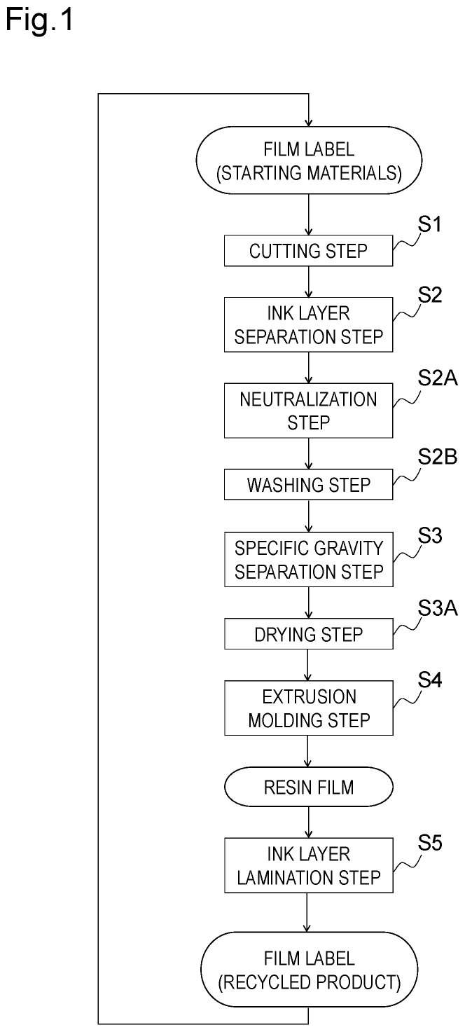

FIG. 1 is a flowchart showing a flow of a method for producing a resin film according to a first embodiment. As shown in FIG. 1, the method for producing a resin film includes a step of preparing a starting material, and subsequent steps S1 to S5. Steps S1 to S4 are steps of recovering a thermoplastic resin having a specific gravity of less than 1 from a starting material, and extruding a resin film having a specific gravity of less than 1 including the recovered thermoplastic resin in the raw material. Step S5 is a step of forming an ink layer of a printing ink on the produced resin film to produce a film label (recycled product) mainly attached to a PET bottle. The film label as a recycled product can be used as a starting material again, and can be subjected to new steps S1 to S5. The order of steps S1, S2, S2A, S2B, and S3 in FIG. 1 can be changed as appropriate. Therefore, in the following, after the method of the first embodiment shown in FIG. 1 is described in detail, other embodiments having different orders of steps will also be described in detail.

### 1-1. Starting Materials

A starting material as a starting point of circulation of the method for producing a resin film shown in FIG. 1 includes a film label. A film label is configured as a label in which a printing layer is formed on a resin film (resin layer) containing a thermoplastic resin as a main component. The film label may or may not be heat shrinkable. The film label may be a film label used as a product, an unused film label, an intermediate treated article, a waste in the production process, or the like, and the history thereof is not particularly limited.

The resin film is roughly classified into an olefin film, a styrene film, and an ester film depending on a main component. The olefin film contains an olefin resin such as polyethylene, polypropylene, cyclic polyolefin, and a petroleum resin. The olefin resin is a hydrocarbon having a carbon-carbon double bond, and examples thereof include an ethylene-based resin, a propylene-based resin, a cyclic olefin-based resin, a petroleum resin, and an olefin elastomer. The olefin film is mainly composed of at least one of polyethylene and polypropylene having a specific gravity of less than 1, and usually has a specific gravity as a whole of less than 1.

The styrene film contains polystyrene (specific gravity: 1.03 to 1.06) as a main component, and usually has a specific gravity as a whole of more than 1. The ester film contains polyethylene terephthalate (specific gravity 1.25 to 1.40) as a main component, and usually has a specific gravity as a whole of more than 1. Therefore, pieces recovered as the thermoplastic resin having a specific gravity of less than 1 in a specific gravity separation step (S3) described later are derived from the olefin film among the resin films.

The film label may be removed from the PET bottle or may be attached to the PET bottle. That is, a single film label, a PET bottle to which a film label is attached, or a mixture thereof may be prepared as the starting material. In a general PET bottle, a container body is made of polyethylene terephthalate (PET), and a cap and a ring portion of the cap attached to the container body are made of polyethylene or polypropylene. Since the cap and the ring portion are also separated on the same side as the olefin film in the specific gravity separation step (S3) described later, the cap and the ring portion can be recovered as resources. The recovered resources of the cap and the ring portion may be included in the raw material of the resin film. Similarly to the film label, a PET bottle as a starting material may be a PET bottle used as a product, an unused PET bottle, an intermediate treated article, a waste in the production process, or the like, and the history thereof is not particularly limited.

### 1-2. Cutting Step

Step S1 is a cutting step of cutting the starting material to obtain pieces in which the starting material is separated into two or more pieces. Hereinafter, the pieces obtained in step S1 may be referred to as pieces (P1). By performing the cutting step prior to an ink separation step described later, the separation of the ink layer in the ink separation step is promoted. When the starting material is a film label alone removed from the PET bottle, the film label is cut in step S1. The method for cutting the film label is not particularly limited, and can be performed using a known slitter, shredder, cutting machine, or the like. The size of the pieces is not particularly limited.

When the starting material includes a film label attached to a PET bottle, the PET bottle is cut together with the film label in step S1. The method for cutting a labeled PET bottle is not particularly limited, and can be performed using a known grinder, cutter, crusher, or the like. Most of the film label is peeled off from the PET bottle in the process of being cut together with the PET bottle. As a result, pieces of the PET bottle and pieces of the film label are each obtained. The size of these pieces is not particularly limited, but is preferably such a size that the container body and the ring portion attached to a neck portion of the container body are separated in the PET bottle. When the PET bottle is cut together with the film label, pieces of the film label may be selected from the obtained pieces, and the selected pieces of the film label may be sent to the ink layer separation step described later. The method for selecting pieces of the film label is not particularly limited, and examples thereof include a method of blowing off pieces of the film label by wind power, a method of collecting pieces of the film label by vibration, and the like.

### 1-3. Ink Layer Separation Step

Step S2 is an ink layer separation (deinking treatment) step of separating the ink layer from the pieces of the film label to obtain pieces of the resin layer from which the ink layer has been removed. Hereinafter, the pieces including the pieces of the resin layer obtained in step S2 are also referred to as pieces (P2).

Since the film label includes the ink layer, the specific gravity as a whole is often larger than the specific gravity of the resin film itself as the base film. The printing ink contains a component having a relatively large specific gravity, and the specific gravity as a whole often exceeds 1. For example, white ink contains titanium oxide having a relatively large specific gravity of 3.9 to 4.1. Therefore, when the film label is simply cut, the thermoplastic resin having a specific gravity of less than 1 may not be appropriately separated from the thermoplastic resin having a specific gravity of more than 1 in the subsequent specific gravity separation step. In particular, when the thickness of the resin film is thin, the specific gravity ratio of the ink layer in the entire film label increases, and thus this tendency becomes remarkable. By performing step S2 before step S3, a large amount of the thermoplastic resin having a specific gravity of less than 1 can be efficiently recovered.

The method for separating the ink layer is not particularly limited, and a known method can be appropriately adopted. Examples of the method include a method of immersing the pieces (P1) in an alkaline aqueous solution, a method of immersing the pieces (P1) in water, a method using a film cleaning device (deinking device), and the like. The pieces (P1) may be pieces of the film label selected before step S2, or may be pieces of the film label including pieces of the PET bottle.

As the film label, a film label that is devised to make it easier to remove an ink layer by the above-described method is known. Examples thereof include a film label having an intermediate layer that dissolves or swells in alkaline hot water between an ink layer and a base material layer made of a thermoplastic resin (see Patent Document 1). By immersing this film label in a NaOH 3% solution at 90° C. for a certain period of time or more, the ink layer is peeled off from the base material layer together with the intermediate layer, and as a result, the ink layer can be removed. The intermediate layer is composed of a resin composition that swells or dissolves in alkaline hot water.

Further, for example, as disclosed in Japanese Patent Laid-Open Publication No. 2001-350411, there is also a film label in which an ink layer swells or dissolves in an alkaline aqueous solution and is easily separated from a resin film. This film label can also be immersed in a NaOH 3% solution at 60° ° C. for a certain period of time to remove the ink layer.

Another example includes a film label having a layer containing polyvinyl alcohol (PVA) as an intermediate layer between a resin film and an ink layer (see Patent Document 2). When this film label is immersed in water at 20° C. to 50° C., the PVA swells, and the ink layer is peeled off together with the PVA from the resin film, and as a result, the ink layer can be removed.

The above-described methods may be appropriately combined. For example, the pieces (P1) may be immersed in water, then pulled up, and further immersed in an alkaline aqueous solution. On the contrary, the pieces (P1) may be immersed in an alkaline aqueous solution, then pulled up, and further immersed in water.

As described above, the pieces (P2) including the pieces of the resin layer from which the ink layer has been removed are obtained.

### 1-4. Neutralization Step

Step S2A can be provided between step S2 and step S3 as necessary. Step S2A is a neutralization step of immersing the pieces (P2) immersed in the alkaline aqueous solution in step S2 in an acidic aqueous solution to neutralize the alkalinity. The acidic aqueous solution is not particularly limited, and for example, an acetic acid aqueous solution can be used. When the alkaline aqueous solution is used in step S2, the amount of water used in a washing step described later can be saved by providing step S2A.

### 1-5. Washing Step

Step S2B can be provided between step S2 and step S3 as necessary. Step S2B is a washing step of immersing the pieces (P1) in the alkaline aqueous solution in step S2, and then washing the alkaline aqueous solution attached to the pieces (P2) with water. Step S2B can be provided in place of or in addition to step S2A.

### 1-6. Specific Gravity Separation Step

Step S3 is a specific gravity separation step of separating the pieces (P2) obtained in step S2 into one composed of a thermoplastic resin having a specific gravity of less than 1 and one composed of a thermoplastic resin having a specific gravity of more than 1. Examples of the specific gravity separation method include a separation method using liquid and a separation method using wind power and the specific gravity separation method is not particularly limited, but specific gravity separation using water is preferable from the viewpoint of being able to perform accurate separation while being simple. That is, when the pieces (P2) are charged into water, pieces of the thermoplastic resin having a specific gravity of less than 1 (hereinafter, also referred to as “pieces (P3)”) float on the water surface, and pieces of the thermoplastic resin having a specific gravity of more than 1 (hereinafter, also referred to as “pieces (P4)”) settle in water. For accuracy of specific gravity separation, the temperature of water into which the pieces (P2) are charged is preferably 20° C. or higher, more preferably 30° C. or higher, and preferably 55° C. or lower, more preferably 45° C. or lower.

As described above, the olefin film, the cap, and the pieces of the ring portion float on the water surface as the pieces (P3). On the other hand, pieces of a styrene film, an ester film, polyethylene terephthalate (container body), overcoat components of an ink layer, and so on settle in water as the pieces (P4). The pieces (P3) and the pieces (P4) thus separated by specific gravity can be separately recovered.

The pieces (P3) may be further separated into pieces derived from the olefin film and pieces derived from the cap and the ring portion by a known method using wind power, vibration, or the like, and the pieces derived from the olefin film may be sent to the subsequent step S4. Among the recovered pieces (P4), both the pieces of polyethylene terephthalate and the pieces of the ester film can be used for preparing recycled pellets. The recycled pellet is used again as a raw material for preparing a container body of a PET bottle, for example. Therefore, step S3 may include a step of recovering the pieces (P4), charging the pieces into a liquid having a different specific gravity again, and more finely separating the pieces by specific gravity in order to separate the styrene film, the ester film, and the polyethylene terephthalate.

### 1-7. Drying Step

The pieces (P3) recovered in step S3 preferably undergo step S3A before an extrusion molding step (S4) described later. Step S3A is a drying step of removing moisture from the pieces (P3) recovered in step S3. The drying method is not particularly limited, and drying can be performed using a hot air dryer, a vacuum dryer, a blower, or the like. The drying temperature is preferably 30° C. or higher, more preferably 40° C. or higher, and preferably 90° ° C. or lower, more preferably 80° C. or lower. By setting the drying temperature to equal to or lower than the above temperature, fusion of the olefin resin can be avoided. Also, when the drying temperature is equal to or higher than the above temperature, the drying time can be shortened. Further, when the pieces (P3) include the olefin film, the cap, and the ring portion, the pieces derived from the olefin film and the pieces derived from the cap and the ring portion may be separated while drying the pieces (P3) in step S3. This separation can be carried out in the known manner already described.

By removing moisture from the pieces (P3) in the drying step, it is possible to avoid manufacturing defects such as generation of air bubbles in the resin film extruded in step S4. Also, when the pieces derived from the olefin film are selected and sent to step S4, the resin film extruded in step S4 is not colored or hardly colored. Therefore, there are few restrictions in the case of being used as a base film, and a film label with higher quality can be prepared.

### 1-8. Extrusion Molding Step

Step S4 is a step of feeding the pieces (P3) to an extruder for melt kneading and extrusion molding to obtain a resin film having a specific gravity of less than 1. Although the resin film is not limited thereto, in the present embodiment, the resin film is stretched after extrusion, and is configured as a film having heat shrinkability.

The pieces (P3) may be kneaded alone, but is preferably kneaded together with another raw material composition (hereinafter, also referred to as “additional raw material”) that is not a recycled raw material. The extrusion may also be co-extrusion. That is, the resin film may be a single layer or a multilayer, and is configured to have a specific gravity as a whole of less than 1 by adjusting blending of the thermoplastic resin derived from the pieces (P3) (hereinafter, also referred to as “recycled raw material (P3)”) and the additional raw material and the balance between the thicknesses of the layers. When the co-extrusion method is performed by a T-die, the lamination method may be a feed block method, a multi-manifold method, or a combination of these methods.

When the resin film has a multilayer structure, the recycled raw material (P3) is preferably contained in the inner layer. In the present embodiment, an olefin resin is combined as an additional raw material, and a resin film having a three-layer structure including a core layer and adjacent layers laminated adjacent to both surfaces of the core layer is co-extruded. The adjacent layer contains an additional raw material, and the core layer contains a recycled raw material (P3) and an additional raw material. The core layer contains the recycled raw material (P3) in an amount of preferably 1% by mass or more, more preferably 5% by mass or more, and preferably 60% by mass or less, more preferably 50% by mass or less, still more preferably 40% by mass or less, with respect to 100% by mass of the total of thermoplastic resins constituting the core layer. That is, the content of the recycled raw material (P3) in the core layer is preferably 1% by mass to 60% by mass, more preferably 5% by mass to 50% by mass, still more preferably 5% by mass to 40% by mass. By blending an appropriate amount of the recycled raw material (P3) in the core layer, the heat shrinkage of the resin film is in a more preferable range, and natural shrinkage is suppressed. In addition, rigidity of the resin film is improved. Such a preferable effect is considered to be caused by a decrease in crystallinity of the resin in the recycled raw material (P3).

The resin film may further include a surface layer laminated adjacent to (the surface opposite to the core layer of) each adjacent layer. That is, the resin film may have a five-layer structure in which a surface layer, an adjacent layer, a core layer, an adjacent layer, and a surface layer are laminated. In this case, similarly to the core layer, the adjacent layer can also contain a recycled raw material (P3) in addition to the additional raw material. That is, in the resin film, the layer other than the outermost layer that is outermost can contain the recycled raw material (P3) in addition to the additional raw material. When the adjacent layer contains the recycled raw material (P3), the adjacent layer contains the recycled raw material (P3) in an amount of preferably 1% by mass or more, more preferably 5% by mass or more, and preferably 60% by mass or less, more preferably 50% by mass or less, still more preferably 40% by mass or less, with respect to 100% by mass of the total of thermoplastic resins constituting the adjacent layer. That is, the content of the recycled raw material (P3) in the adjacent layer is preferably 1% by mass to 60% by mass, more preferably 5% by mass to 50% by mass, still more preferably 5% by mass to 40% by mass.

Examples of the olefin resin as an additional raw material include an ethylene-based resin, a propylene-based resin, a cyclic olefin-based resin, a petroleum resin, and a mixed resin obtained by mixing at least two of these resins. These resins can be used for any of the core layer, the adjacent layer, and the surface layer. Hereinafter, each resin will be described.

### [Ethylene-Based Resin]

Examples of the ethylene-based resin include linear low-density polyethylenes, branched low-density polyethylenes, ethylene-vinyl acetate copolymers, ionomer resins, and mixtures thereof. Furthermore, examples of the ethylene-based resin include a copolymer of ethylene and an α-olefin. The α-olefin is not particularly limited, and examples thereof include 1-butene, 1-pentene, 1-hexene, 4-methyl-1-pentene, and 1-octene, and may include two or more kinds of α-olefins. The copolymer may be a random copolymer or a block copolymer. The linear low-density polyethylene usually has a specific gravity of 0.910 to 0.940. Also, the ethylene-based resin may contain an ethylene elastomer or the like.

Examples of commercially available products of the linear low-density polyethylene resin as described above include Evolue (manufactured by Prime Polymer Co., Ltd.), UMERIT (manufactured by Ube-Maruzen Polyethylene Co., Ltd.), NOVATEC (manufactured by Japan Polyethylene Corporation), and the like. Also, examples of commercially available products of the low-density polyethylene resin include SUMIKATHENE (manufactured by Sumitomo Chemical Co., Ltd.), NOVATEC (manufactured by Japan Polyethylene Corporation), and the like.

### [Propylene-Based Resin]

When the resin film exhibits heat shrinkability, the propylene-based resin is preferably a binary or ternary random copolymer containing propylene as a main component and α-olefin as a copolymerization component. The ratio of the α-olefin as a copolymerization component is preferably 1 to 10 mol %. Also, the propylene-based resin may be a mixture of different propylene-α-olefin random copolymers. The α-olefin is as described above. The propylene-based resin usually has a specific gravity of 0.900 to 0.910. In addition, the propylene-based resin may contain long-chain branched polypropylene, propylene elastomer, or the like.

The long-chain branched polypropylene is a polypropylene having a long-chain branched structure also referred to as a comb structure, and examples thereof include metallocene polypropylene. The long-chain branched structure polypropylene is more likely to entangle between molecules due to its structure, and is excellent in shape retention.

Examples of commercially available products of the propylene-based resin as described above include Adsyl (manufactured by Basell), NOVATEC (manufactured by Japan Polypropylene Corporation), WAYMAX (manufactured by Japan Polypropylene Corporation), TAFMER (manufactured by Mitsui Chemicals, Inc.), Thermorun (manufactured by Mitsubishi Chemical Corporation), and the like.

### [Cyclic Olefin-Based Resin]

The cyclic olefin-based resin can lower the crystallinity of the resin film, increase the heat shrinkage, and also increase stretchability during production. The cyclic olefin-based resin is, for example, (a) a random copolymer of ethylene or propylene and a cyclic olefin, (b) a ring-opened polymer of the cyclic olefin or a copolymer with an α-olefin, (c) a hydrogenated product of the polymer of (b), (d) a graft-modified product of (a) to (c) with an unsaturated carboxylic acid, a derivative thereof, or the like, or the like.

The cyclic olefin is not particularly limited, and examples thereof include norbomnene and derivatives thereof such as norbornene, 6-methylnorbomene, 6-ethylnorbornene, 5-propylnorbornene, 6-n-butylnorbomene, 1-methylnorbornene, 7-methylnorbornene, 5,6-dimethylnorbornene, 5-phenylnorbornene, and 5-benzylnorbornene. Furthermore, examples thereof include tetracyclododecene and derivatives thereof such as tetracyclododecene, 8-methyltetracyclo-3-dodecene, 8-ethyltetracyclo-3-dodecene, and 5,10-dimethyltetracyclo-3-dodecene. The α-olefin is as described above.

Examples of commercially available products of the cyclic olefin-based resin as described above include APEL (manufactured by Mitsui Chemicals, Inc.), TOP AS COC (manufactured by Polyplastics Co., Ltd.), ZEONOR (manufactured by Zeon Corporation), and the like.

### [Petroleum Resin]

The petroleum resin is a resin obtained by polymerizing a C5 fraction or a C9 fraction produced by thermal decomposition of naphtha, or a mixture thereof, and a hydrogenated product thereof. Examples of such a resin include aromatic petroleum resins, aliphatic petroleum resins, aromatic hydrocarbon resin petroleum resins, alicyclic saturated hydrocarbon resin petroleum resins, copolymers of the above petroleum resins, and hydrogenated products of these petroleum resins. Among them, an alicyclic petroleum resin having a partially or completely hydrogenated alicyclic structure is preferable from the viewpoint of suppressing softening of the resin film at 100° C. or lower and securing transparency and rigidity. Specific examples of the alicyclic petroleum resin include alicyclic saturated hydrocarbon resin petroleum resins and hydrogenated products of aromatic petroleum resins. It is also possible to use a product obtained by purifying and polymerizing a single component or a plurality of components in the C5 fraction and the C9 fraction.

Examples of commercially available products of the petroleum resin as described above include I-MARV (manufactured by Idemitsu Kosan Co., Ltd.), ARKON (manufactured by Arakawa Chemical Industries Ltd.), Regalite (manufactured by Eastman Chemical Company), and the like.

In addition, additives such as an antioxidant, a heat stabilizer, an ultraviolet absorber, a light stabilizer, a lubricant, an antistatic agent, a flame retardant, an antibacterial agent, a fluorescent brightener, and a colorant may be added to the resin film as necessary.

The resin film of the present embodiment is extruded, then cooled and solidified while being wound up by a take-off roll, and then uniaxially or biaxially stretched. As a stretching method, for example, any of a roll stretching method, a tenter stretching method, or a combination thereof can be adopted. The stretching temperature is not limited thereto, but is preferably 65° C. or higher, more preferably 70° C. or higher, and preferably 125° C. or lower, preferably 120° C. or lower, more preferably 115° C. or lower. That is, the stretching temperature is preferably 65° C. to 125° C., more preferably 70° ° C. to 120° C., still more preferably 70° C. to 115° C. The stretch ratio in the main shrinkage direction is not limited thereto, but is preferably 3 times or more, more preferably 4 times or more, and preferably 7 times or less, more preferably 6 times or less. That is, the stretch ratio in the main shrinkage direction is preferably 3 times to 7 times, more preferably 4 times to 6 times.

By step S4, a resin film containing the recycled raw material (P3) and having a specific gravity of less than 1 is prepared. This resin film has an ink layer laminated in the next step S5, and can be suitably used as a film label for PET bottles. However, the present invention is not limited thereto, and can be used as a film label of a container other than PET bottles, or can be used as a packaging material as a resin film.

### 1-9. Ink Layer Lamination Step

Step S5 is a step of laminating an ink layer with a printing ink on the resin film prepared in step S4. The method for laminating an ink layer is not particularly limited. For example, printing may be performed on the outermost layer, and an ink layer may be laminated on the surface of the outermost layer. In this case, the printing ink that forms the ink layer is preferably one that easily swells or dissolves in an alkaline aqueous solution as described above, for example. In addition, printing may not be performed on the outermost layer, and a printed thermoplastic resin film on which an ink layer has been formed may be separately prepared and laminated on the outermost layer. In this case, from the viewpoint of easily separating the ink layer and the resin film by specific gravity later, it is preferable to provide an intermediate layer composed of a resin composition that easily swells or dissolves in water or an alkaline aqueous solution between the printed thermoplastic resin film and the outermost layer. In any of the above cases, the printing method is not particularly limited, and known methods such as offset printing, gravure printing, flexographic printing, inkjet printing, and screen printing can be adopted. An overcoat layer may be appropriately laminated on the ink layer.

In step S5, for example, a sheet of a film label in which a large number of film labels are connected is obtained by sequentially laminating an ink layer on a resin film wound in a roll while sequentially feeding the resin film. After the obtained sheet is slit to an appropriate width, both ends are sealed to prepare a film label connected in a cylindrical shape. The sealing method is not particularly limited, and known methods such as heat sealing, ultrasonic sealing, sealing with an adhesive, and sealing with an organic solvent can be adopted.

When the cylindrical film label thus prepared is attached to a PET bottle and heated together with the PET bottle, the film label is thermally shrunk and adheres to the PET bottle so as to follow the outer shape of the PET bottle. In this way, a PET bottle to which a film label is attached is prepared. The heating method is not particularly limited, and may be a method by hot air or a method by steam.

The film label of the recycled product subjected to steps S1 to S5 can be distributed together with the PET bottle. Thereafter, the film label can be used again as a starting material. Circulation from the starting material to the recycled product is preferably repeated twice or more.

### Second Embodiment

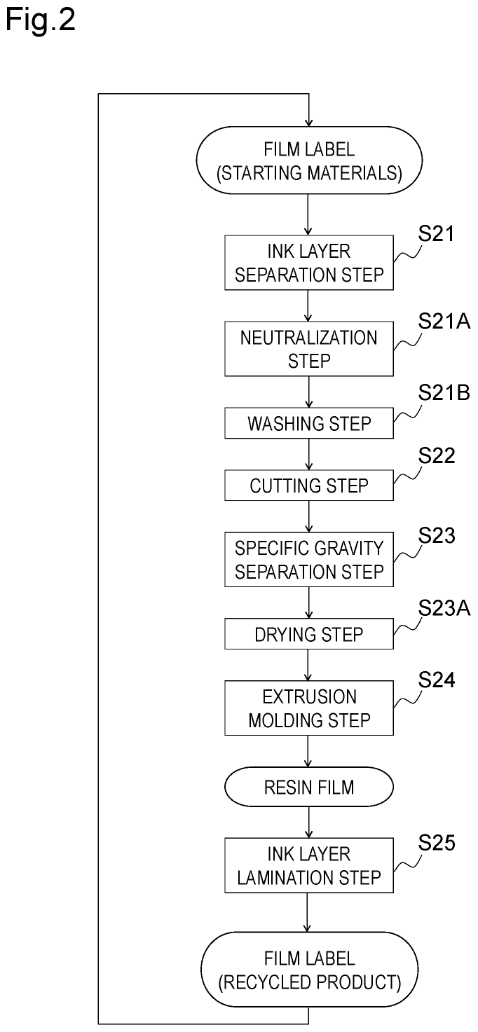

FIG. 2 is a flowchart showing a flow of a production method according to a second embodiment. The method for producing a resin film according to the second embodiment is common to that of the first embodiment in terms of the steps included until the thermoplastic resin having a specific gravity of less than 1 is recovered from the starting material, but the order of performing the steps is different from that of the first embodiment. Hereinafter, description of configurations common to the first embodiment will be omitted, and differences from the first embodiment will be mainly described.

Step S21 is an ink layer separation step of separating the ink layer from the film label of the starting material to obtain a resin layer from which the ink layer has been removed. The method for performing step S21 is common to step S2, but is different from that of the first embodiment in that the method is executed on a film label that is not cut. Therefore, from the viewpoint of efficiency, it is preferable to prepare a film label alone as a starting material. The production method according to the second embodiment may further include step S21A as a neutralization step and step S21B as a washing step after step S21. Step S21A and step S21B are common to step S2A and step S2B of the first embodiment, respectively.

The subsequent step S22 is a cutting step of cutting the resin layer (which may include the PET bottle) obtained in step S21 into pieces, and is common to step S1 of the first embodiment. By performing the cutting step after the ink layer separation step, machines such as a grinder, a cutter, a crusher, a shredder, and a slitter are prevented from being contaminated with the printing ink. By step S22, pieces of the resin layer (which may include pieces of the PET bottle) are obtained.

Steps S23 to S25 after step S22 are executed on the pieces obtained in step S22, and are common to steps S3 to S5 of the first embodiment. Therefore, description thereof is omitted.

### Third Embodiment

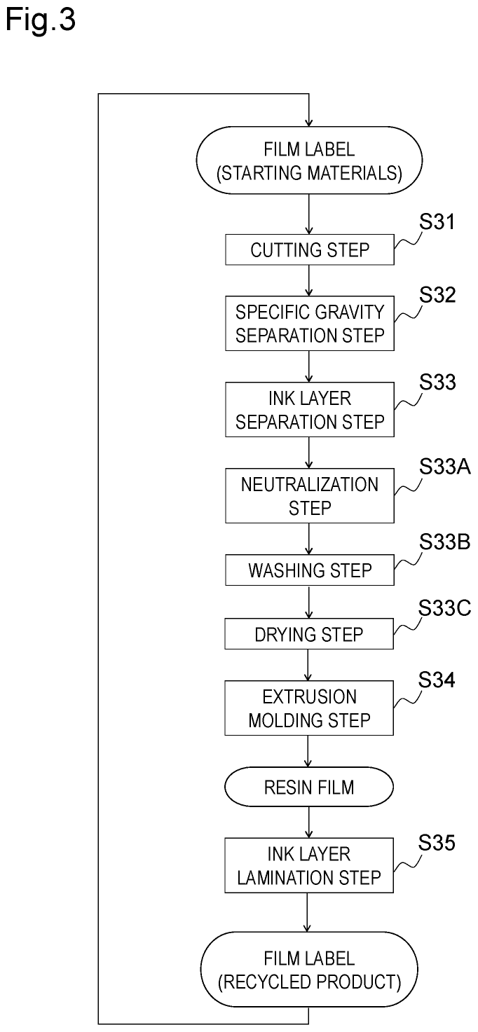

FIG. 3 is a flowchart showing a flow of a production method according to a third embodiment. The method for producing a resin film according to the third embodiment is common to those of the first and second embodiments in terms of the steps included until the thermoplastic resin having a specific gravity of less than 1 is recovered from the starting material, but the order of performing the steps is different from those of these embodiments. Hereinafter, description of configurations common to the first embodiment will be omitted, and differences from the first embodiment will be mainly described.

Step S31 is a cutting step of cutting the starting material to obtain pieces in which the starting material is separated into two or more pieces, and is common to step S1 of the first embodiment. The subsequent step S32 is a specific gravity separation step of separating the pieces obtained in step S31 into pieces having a specific gravity of less than 1 and pieces having a specific gravity of more than 1. The method for performing step S32 is common to step S3 of the first embodiment, but is different from that of the first embodiment in that the step is performed prior to the ink layer separation step. In step S32, among the pieces of the starting material, pieces of the olefin film label, pieces of the cap, and pieces of the ring portion are separated from pieces of the styrene film label, pieces of the ester film label, and pieces of the container body. The pieces having a specific gravity of less than 1 may be collectively sent to the subsequent step S33, or the pieces of the olefin film label may be particularly selected by the known method already exemplified and sent to step S33.

The subsequent step S33 is an ink layer separation step of separating the ink layer from the pieces of the olefin film label having a specific gravity of less than 1 to obtain pieces of the resin layer from which the ink layer has been removed. The method of performing step S33 is common to step S3 of the first embodiment. In step S33, pieces of the resin layer mainly composed of the olefin resin are obtained. By performing step S32 before step S33, the separated ink layer is prevented from adhering to the pieces of the container body of the PET bottle. The production method according to the third embodiment may further include step S33A as a neutralization step, step S33B as a washing step, and step S33C as a drying step after step S33. Step S33A, step S33B and step S33C are common to step S2A, step S2B and step S3A, respectively. Further subsequent step S34 and step S35 are common to step S4 and step S5, respectively. Therefore, description thereof is omitted.

### 1-10. Characteristics

According to the method for producing a resin film according to the present embodiment, a resin film having a specific gravity of less than 1 contained in the film label can be reused by a relatively simple step. In particular, by reproducing a resin film having a specific gravity of less than 1 from the resin film, circulation from the film label to the film label is formed. In addition, the heat shrinkage, rigidity, and natural shrinkage of the olefin resin film can be made preferable by using a recycled material.

### 2. Olefin Film

Hereinafter, some examples of the olefin film that can be contained in the resin layer of the starting material according to the production method and the resin film having a specific gravity of less than 1 that can be produced by the production method will be described in detail. The following olefin films are all configured as heat shrinkable films. Also, the following olefin film on which an ink layer has been laminated is configured as a film label.

### 2-1. First Olefin Film

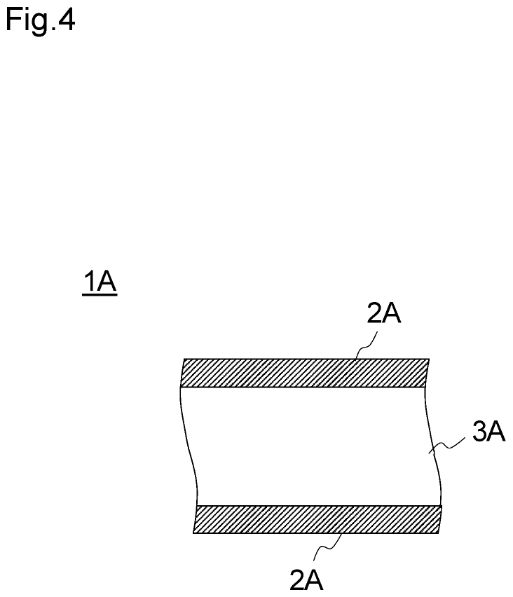

FIG. 4 shows a cross section of an olefin film 1A (hereinafter, it is also simply referred to as a “film 1A”) as a first example. The film 1A can be included in both the resin layer of the starting material according to the production method and the resin film produced by the production method. As shown in FIG. 4, the film 1A includes an adjacent layer 2A and a core layer 3A. The adjacent layer 2A is a layer laminated on at least one surface of the core layer 3A adjacent to the core layer 3A, and in the example shown in FIG. 4, the adjacent layer 2A is laminated adjacent to both surfaces of the core layer 3A. The thickness of each layer shown in FIG. 4 does not necessarily reflect actual dimension. The adjacent layer 2A and the core layer 3A are mainly composed of an olefin resin.

Since the film 1A is configured to have a specific gravity as a whole of less than 1, it is possible to separate the film 1A by specific gravity from an ester resin or a styrene resin having a specific gravity of more than 1 at the site of recycling. Thus, the film 1A can be used as a recycled raw material of the olefin resin. In particular, in the case of reproducing the film 1A having substantially the same configuration using the film 1A as a raw material, resource circulation from the heat shrinkable film to the heat shrinkable film is formed. Specifically, not only the film 1A itself but also a film having an ink layer provided on the film 1A and configured as a heat shrinkable label can be reused as a raw material of the film 1A by being subjected to the deinking treatment as described above, and a heat shrinkable film having excellent transparency can be reproduced. Therefore, the heat shrinkable label including the film 1A may include the above-described intermediate layer between the adjacent layer 2A and the ink layer in order to separate the ink layer in the ink layer removing step. Also, even when the heat shrinkable label including the film 1A does not include the intermediate layer, the ink layer may be formed using a printing ink that can be dissolved in an alkaline solution or the like as described above. Therefore, the film 1A includes a film composed of an unreused virgin material, and also, a film composed of an additional raw material and a reused olefin resin (recycled raw material (P3)). Hereinafter, each layer of the film 1A will be described.

### 2-1-1. Adjacent Layer (Surface Layer)

The adjacent layer 2A contains an ethylene-based resin, a cyclic olefin-based resin, and a petroleum resin. Since the outline of these resins has already been described in the first embodiment, redundant description will be omitted and additional matters will be described below.

### [Ethylene-Based Resin]

The ethylene-based resin improves grease resistance of the film 1A. When the cyclic olefin-based resin is touched by a human hand or the like before the film 1A is thermally shrunk and a fat component adheres thereto, the film 1A is likely to cause whitening (hereinafter, also referred to as sebum whitening) at the portion after shrinkage. When the adjacent layer 2A contains an appropriate amount of the ethylene-based resin, the film 1A is less likely to cause sebum whitening, and the grease resistance is improved. The adjacent layer 2A preferably contains linear low-density polyethylene as the ethylene-based resin.

The ethylene-based resin preferably has a density of 880 kg/m³ or more and 940 kg/m³ or less. Also, the ethylene-based resin preferably has a melt flow rate (MFR) at 190° ° C. of 0.1 g/10 min or more and 30 g/10 min or less. This improves compatibility with a cyclic olefin-based resin described later.

The ethylene-based resin preferably has a Vicat softening temperature of 90° C. or higher and 110° C. or lower. The Vicat softening temperature can be measured by a method in accordance with JISK-7206 (1999). Also, the ethylene-based resin preferably has a melting point of 95° C. or higher and 120° C. or lower.

The adjacent layer 2A contains the ethylene-based resin in an amount of preferably 10% by mass or more, preferably 15% by mass or more, and preferably 35% by mass or less, more preferably 30% by mass or less, based on 100% by mass of the total of the ethylene-based resin, the cyclic olefin-based resin, and the petroleum resin constituting the adjacent layer 2A. That is, the adjacent layer 2A contains the ethylene-based resin in an amount of preferably 10% by mass to 35% by mass, more preferably 15% by mass to 30% by mass. When the content of the ethylene-based resin is equal to or more than the lower limit, likelihood of causing sebum whitening of the cyclic olefin-based resin is covered, and the grease resistance of the film 1A is improved. Also, when the content of the ethylene-based resin is equal to or less than the upper limit, deterioration of transparency of the film 1A due to the ethylene-based resin is suppressed.

### [Cyclic Olefin-Based Resin]

The cyclic olefin-based resin is preferably a random copolymer of a cyclic olefin and ethylene, propylene, or α-olefin from the viewpoint of reducing the crystallinity of the film 1A and improving stretchability, heat shrinkage, and transparency during production.

The cyclic olefin-based resin preferably has a number average molecular weight measured by a GPC (gel permeation chromatography) method of 1000 or more and 1 million or less. When the number average molecular weight is within the above range, film formation is facilitated.

The cyclic olefin-based resin has a glass transition temperature of preferably 20° C. or higher, more preferably 50° C. or higher, and preferably 130° C. or lower, more preferably 100° C. or lower. That is, the cyclic olefin-based resin has a glass transition temperature of preferably 20° ° C. to 130° C., more preferably 50° ° C. to 100° C. When the glass transition temperature is 20° C. or higher, heat resistance of the adjacent layer 2A is improved. In addition, in an attachment line for attaching a heat shrinkable label including the film 1A to a container, occurrence of blocking between these containers can be suppressed. Further, when the glass transition temperature is 50° C. or higher, the natural shrinkage can be in a favorable range. When the glass transition temperature is 130° C. or lower, the heat shrinkage in the main shrinkage direction can be sufficiently increased. Furthermore, when the glass transition temperature is 100° C. or lower, the heat shrinkage in the main shrinkage direction can be sufficiently increased even in a low temperature range.

The glass transition temperature can be measured by a method in accordance with ISO 3146. When the cyclic olefin-based resin is a mixed resin containing a plurality of cyclic olefin-based resins having different glass transition temperatures, the glass transition temperature of the mixed resin is an apparent glass transition temperature calculated based on the mass ratio of each cyclic olefin-based resin in the mixed resin and the glass transition temperature.

The adjacent layer 2A preferably contains two kinds of cyclic olefin-based resins having different glass transition temperatures. Among these cyclic olefin-based resins, when one having a glass transition temperature of Tg1 (C) is defined as a first cyclic olefin-based resin (A1), and one having a glass transition temperature of Tg2 (° C.) is defined as a second cyclic olefin-based resin (A2), the difference between Tg1 and Tg2 is preferably 10° C. or more. Furthermore, Tg1>70° C. is preferable, and Tg2≤ 70° C. is preferable.

When the cyclic olefin-based resin is a mixed resin containing the first cyclic olefin-based resin (A1) and the second cyclic olefin-based resin (A2), thermal characteristics of the mixed resin can be gently developed across the apparent glass transition temperature. This improves processability during stretching of the film 1A. In addition, since shrinkage during heat shrinkage of the film 1A is not rapid, occurrence of wrinkles due to heat shrinkage can be suppressed. Furthermore, by setting the difference between Tg1 and Tg2 to 10° C. or more, the natural shrinkage of the film 1A can be suppressed, whereas the heat shrinkage can be increased. These characteristics can be adjusted by blending ratios of the first cyclic olefin-based resin (A1) and the second cyclic olefin-based resin (A2).

The cyclic olefin-based resin has a density of preferably 1000 kg/m³ or more, more preferably 1010 kg/m³ or more, and preferably 1050 kg/m³ or less, more preferably 1040 kg/m³ or less. That is, the cyclic olefin-based resin has a density of preferably 1000 kg/m³ to 1050 kg/m³, more preferably 1010 kg/m³ to 1040 kg/m³. In addition, the cyclic olefin-based resin preferably has an MFR at 230° C. of 1 g/10 min or more and 10 g/10 min or less. This improves compatibility with the above-described ethylene-based resin.

The adjacent layer 2A contains the cyclic olefin-based resin in an amount of preferably 50% by mass or more, more preferably 55% by mass or more, and preferably 75% by mass or less, more preferably 70% by mass or less, based on 100% by mass of the total of the ethylene-based resin, the cyclic olefin-based resin, and the petroleum resin constituting the adjacent layer 2A. That is, the adjacent layer 2A contains the cyclic olefin-based resin in an amount of preferably 50% by mass to 75% by mass, more preferably 55% by mass to 70% by mass. When the content of the cyclic olefin-based resin is equal to or more than the lower limit, the stretchability, heat shrinkage, and transparency of the film 1A are improved. On the other hand, the cyclic olefin-based resin is weak against a fat component such as a fatty acid ester, and a portion to which the fat component adheres in the film 1A also causes sebum whitening after shrinkage. When the content of the cyclic olefin-based resin is equal to or less than the upper limit, the ethylene-based resin and a petroleum resin described later effectively suppress sebum whitening, and the grease resistance of the film 1A is improved.

### [Petroleum Resin]

The petroleum resin effectively suppresses sebum whitening of the cyclic olefin-based resin, and when the content is increased, stickiness is likely to occur on the surface of the layer. The inventor has found that when an alicyclic petroleum resin is particularly selected as a petroleum resin, sebum whitening can be effectively suppressed while sufficiently suppressing stickiness of the surface. This is considered to be because of high compatibility with a cyclic olefin-based resin structurally similar to the alicyclic petroleum resin. In addition, it has been also confirmed that when the alicyclic petroleum resin and the cyclic olefin-based resin are each contained in different layers, the connection between the layers is strengthened, and delamination hardly occurs.

The petroleum resin has a number average molecular weight measured by a GPC method of preferably 500 or more, more preferably 600 or more, and preferably 1000 or less, more preferably 900 or less. That is, the petroleum resin has a number average molecular weight of preferably 500 to 1000, more preferably 600 to 900. By setting the number average molecular weight within the above range, rigidity of the film 1A is improved.

The petroleum resin has a softening point of preferably 80° C. or higher, more preferably 110° C. or higher, and preferably 170° C. or lower, more preferably 155° C. or lower. That is, the petroleum resin has a softening point of preferably 80° C. to 170° ° C., more preferably 110° ° C. to 155° C. When the petroleum resin has a softening point of lower than 80° C., heat resistance of the film 1A is lowered, and the petroleum resin component may be easily bled out to the surface in a high-temperature atmosphere. When the softening point is higher than 170° C., molding processability such as extrusion film formability and stretching processability may be deteriorated. On the other hand, when the petroleum resin has a softening point of 110° C. or higher, natural shrinkage of the film 1A can be suppressed, and when the petroleum resin has a softening point of 155° C. or lower, the film 1A can be uniformly stretched in the stretching step, which is preferable. In addition, in particular, when the petroleum resin has a softening point of 120° C. or higher and 140° C. or lower, good heat shrinkage can be exhibited. The softening point of the petroleum resin can be measured by a method in accordance with JIS K2207: 2006.

The petroleum resin has a density of preferably 950 kg/m³ or more, more preferably 980 kg/m³ or more, and preferably 1050 kg/m³ or less, more preferably 1020 kg/m³ or less. That is, the petroleum resin has a density of preferably 950 kg/m³ to 1050 kg/m³, and more preferably 980 kg/m³ to 1020 kg/m³. When the petroleum resin has a density within the above range, the rigidity of the film 1A is improved.

The petroleum resin has a refractive index at 20° ° C. of preferably 1.0 or more, more preferably 1.2 or more, and preferably 2.0 or less, more preferably 1.8 or less. That is, the petroleum resin has a refractive index of preferably 1.0 to 2.0, more preferably 1.2 to 1.8. When the petroleum resin has a refractive index of within the above range, the transparency of the film 1A is improved.

The adjacent layer 2A contains the petroleum resin in an amount of preferably 5% by mass or more, preferably 25% by mass or less, based on 100% by mass of the total of the ethylene-based resin, the cyclic olefin-based resin, and the petroleum resin constituting the adjacent layer 2A. That is, the adjacent layer 2A preferably contains the petroleum resin in an amount of 5% by mass to 25% by mass. When the content of the petroleum resin is equal to or more than the lower limit, the likelihood of causing sebum whitening of the cyclic olefin-based resin is covered, and the grease resistance of the film 1A is improved. When the content of the petroleum resin is equal to or less than the upper limit, stickiness of the film 1A is suppressed.

### [Fine Particles]

The adjacent layer 2A may further contain fine particles. The fine particles can be added, for example, to improve anti-blocking performance of the film 1A. As such fine particles, either organic fine particles or inorganic fine particles can be used. As the organic fine particles, organic fine particles such as acrylic resin fine particles, styrene resin fine particles, styrene-acrylic resin fine particles, urethane resin fine particles, and silicone resin fine particles can be used. In particular, acrylic resin fine particles are preferable, and polymethyl methacrylate crosslinked fine particles are still more preferable from the viewpoint of compatibility with the cyclic olefin-based resin.

Examples of commercially available products of the organic fine particles as described above include Techpolymer (manufactured by Sekisui Plastics Co., Ltd.), FINE SPHERE (manufactured by Nippon Paint Co., Ltd.), GANZPEARL (manufactured by Aica Kogyo Company, Ltd.), Art Pearl (manufactured by Negami Chemical Industrial Co., Ltd.), and the like.

As the inorganic fine particles, for example, silica, zeolite, alumina, or the like can be used.

The adjacent layer 2A contains the above-described fine particles in an amount of preferably 0.01 parts by mass or more, more preferably 0.03 parts by mass or more, and preferably 0.10 parts by mass or less, more preferably 0.08 parts by mass or less, based on 100 parts by mass of the total of the resin components constituting the adjacent layer 2A. That is, the adjacent layer 2A contains the fine particles in an amount of preferably 0.01 parts by mass to 0.10 parts by mass, more preferably 0.03 parts by mass to 0.08 parts by mass.

### 2-1-2. Core Layer

The core layer 3A contains a propylene-based resin and a petroleum resin as the olefin resins. Also, the core layer 3A may further contain an ethylene-based resin and a cyclic olefin-based resin. In particular, when the film 1A is recycled as a recycled raw material (P3), the recycled raw material (P3) is preferably used as a raw material of the core layer 3A. That is, the core layer 3A preferably contains all the same olefin resins as the adjacent layer 2A. Each resin will be described below.

### [Propylene-Based Resin]

The core layer 3A may contain one kind or two or more kinds among the above-described propylene-based resins. For example, since the long-chain branched polypropylene is excellent in shape retention as described above, it is useful for suppressing the return of the petroleum resin after heat shrinkage and maintaining shape retention of the core layer 3A. In addition, the long-chain branched polypropylene has high melt tension and strain curability, thus, when the core layer 3A contains the long-chain branched polypropylene, the thickness of the core layer 3A is accurately controlled.

The deflection temperature under load (0.45 MPa) of the propylene-based resin is preferably 120° C. or lower, preferably 90° C. or lower. When the propylene-based resin is a mixed resin containing two or more propylene-based resins having different deflection temperatures under load, the deflection temperature under load of the propylene-based resin means an apparent deflection temperature under load calculated by summing the product of the deflection temperature under load of each propylene-based resin and the blending ratio (mass ratio).

The propylene-based resin preferably has an MFR at 230° ° C. of 0.1 g/10 min or more and 30 g/10 min or less.

The propylene elastomer is, but not limited to, a resin obtained by imparting rubber elasticity to a copolymer of propylene and ethylene or another α-olefin, and imparts heat shrinkage and impact resistance to the film 1A. In addition, transparency of the core layer 3A is maintained, and the core layer 3A is excellent in compatibility with a propylene-based resin not configured as an elastomer.

The core layer 3A without containing the recycled raw material (P3) contains the propylene copolymer in an amount of preferably 50% by mass or more, more preferably 65% by mass or more, and preferably 90% by mass or less, more preferably 80% by mass or less, based on 100% by mass of the total of thermoplastic resins constituting the core layer 3A. That is, the core layer 3A contains the propylene copolymer in an amount of preferably 50% by mass to 90% by mass, more preferably 65% by mass to 80% by mass. Also, the core layer 3A contains the long-chain branched polypropylene in an amount of preferably 15% by mass or less, more preferably 10% by mass or less, based on 100% by mass of the total of thermoplastic resins constituting the core layer 3A. Furthermore, the core layer 3A preferably contains the propylene elastomer in an amount of 10% by mass or less, based on 100% by mass of the total of thermoplastic resins constituting the core layer 3A.

### [Petroleum Resin]

The petroleum resin is as already described in the description of the adjacent layer 2A. The core layer 3A preferably contains the same petroleum resin as that of the adjacent layer 2A. When the core layer 3A does not contain the recycled raw material (P3), the core layer 3A contains the petroleum resin in an amount of preferably 10% by mass or more, more preferably 15% by mass or more, and preferably 45% by mass or less, based on 100% by mass of the total of the propylene-based resin and the petroleum resin constituting the core layer 3A. That is, the core layer 3A contains the petroleum resin in an amount of preferably 10% by mass to 45% by mass, more preferably 15% by mass to 45% by mass. By setting the content of the petroleum resin within the above range, glossiness and heat shrinkage of the film 1A are improved.

When the core layer 3A contains the recycled raw material (P3), the core layer 3A contains the recycled raw material (P3) in an amount of preferably 1% by mass to 60% by mass, more preferably 5% by mass to 50% by mass, still more preferably 5% by mass to 40% by mass, based on 100% by mass of the total of thermoplastic resins constituting the core layer 3A. In addition, the core layer 3A in this case contains the propylene-based resin in an amount of preferably 30% by mass to 60% by mass, more preferably 35% by mass to 55% by mass. Furthermore, the core layer 3A in this case contains the petroleum resin in an amount of preferably 10% by mass to 35% by mass, more preferably 15% by mass to 25% by mass.

### [Other Resins]

The core layer 3A can further contain an ethylene-based resin and a cyclic olefin-based resin. These resins are as already described, and the core layer 3A can contain all the same kind of thermoplastic resins as the thermoplastic resins contained in the adjacent layer 2A. The adjacent layer 2A and the core layer 3A may be different from each other as long as the same kind of thermoplastic resins has the same tendency in properties. When the core layer 3A contains an ethylene-based resin and a cyclic olefin-based resin, the heat shrinkage of the film 1A is further improved.

### 2-1-3. Other Components

The adjacent layer 2A and the core layer 3A may each contain additives such as an antioxidant, a heat stabilizer, an ultraviolet absorber, a light stabilizer, a lubricant, an antistatic agent, a flame retardant, an antibacterial agent, a fluorescent brightener, and a colorant as necessary.

### 2-1-4. Thickness

The entire film 1A has a thickness of preferably 20 μm or more, more preferably 25 μm or more, and preferably 60 μm or less, more preferably 50 μm or less. That is, the entire film 1A has a thickness of more preferably 20 μm to 60 μm, more preferably 25 μm to 50 μm. Also, when the thickness of the adjacent layer 2A is 1, the thickness of the core layer 3A is preferably 4 or more.

### 2-1-5. Heat Shrinkage

When the film 1A is immersed in hot water at 70° C. for 10 seconds, then immersed in water at 20° C. for 10 seconds, and taken out, the film 1A has a heat shrinkage in the main shrinkage direction of preferably 10% or more. In addition, when the film 1A is immersed in hot water at 80° C. for 10 seconds and then immersed in water at 20° C. for 10 seconds, the film 1A has a heat shrinkage in the main shrinkage direction of preferably 41% or more. Furthermore, when the film 1A is immersed in hot water at 90° C. for 10 seconds and then immersed in water at 20° C. for 10 seconds, the film 1A has a heat shrinkage in the main shrinkage direction of preferably 52% or more. When the heat shrinkage is within the above-mentioned range, the film 1A does not cause problems such as shrinkage failure, and can be suitably used particularly as a heat shrinkable film to be attached to a container.

### 2-1-6. Natural Shrinkage

When the film 1A is allowed to stand in an atmosphere at 40° C. for 7 days, the film 1A has a natural shrinkage in the main shrinkage direction of preferably less than 4.0%, more preferably less than 3.0%. When the natural shrinkage is less than 4.0%, shrinkage at the time of storing the film 1A is small, and the film 1A is less likely to cause shrinkage failure in the step of heat shrinkage.

### 2-1-7. Production Method

When the core layer 3A contains the recycled raw material (P3), the film 1A can be produced by the production methods according to the first to third embodiments. In addition, the method for producing the film 1A when the core layer 3A does not contain the recycled raw material (P3), that is, when the core layer 3A is composed of a virgin raw material is not particularly limited, but a method of simultaneously molding each layer by a co-extrusion method is preferable. When the co-extrusion method is co-extrusion by a T-die, the lamination method may be a feed block method, a multi-manifold method, or a method using these methods in combination.

Specifically, for example, there is a method in which raw materials constituting the adjacent layer 2A and the core layer 3A described above are each charged into an extruder, extruded into a sheet shape by a die, cooled and solidified by a take-off roll, and then stretched uniaxially or biaxially. As a stretching method, for example, a roll stretching method, a tenter stretching method, or a combination thereof can be used. The stretching temperature is changed according to the softening temperature of the resin constituting the film 1A, shrinkage characteristics required for the film 1A, and the like, but the stretching temperature is preferably 65° C. to 125° C., more preferably 70° ° C. to 120° C., still more preferably 70° C. to 115° C.

The stretch ratio in the main shrinkage direction is changed according to the resin constituting the film 1A, the stretching means, the stretching temperature, and the like, but is preferably 3 to 7 times, more preferably 4 to 6 times.

### 2-1-8. Characteristics

In the film 1A, when the adjacent layer 2A contains a cyclic olefin-based resin, an ethylene-based resin, and a petroleum resin in appropriate ranges, the film 1A has higher grease resistance and transparency while achieving sufficient heat shrinkage as a heat shrinkable film. In addition, when the adjacent layer 2A contains two kinds of cyclic olefin-based resins having different glass transition temperatures, the natural shrinkage is suppressed in a preferable range, and the heat shrinkage can be sufficiently high. Moreover, when the core layer 3A contains the same thermoplastic resins as the thermoplastic resins contained in the adjacent layer 2A, it is easy to recycle the film 1A and the heat shrinkable label containing the film 1A into the heat shrinkable film. Furthermore, when the core layer 3A having the highest contribution ratio to the heat shrinkage of the film 1A contains the long-chain branched polypropylene, the heat shrinkage of the film 1A is further improved, the return after heat shrinkage is suppressed, and shape retention is enhanced.

### 2-2. Second Olefin Film

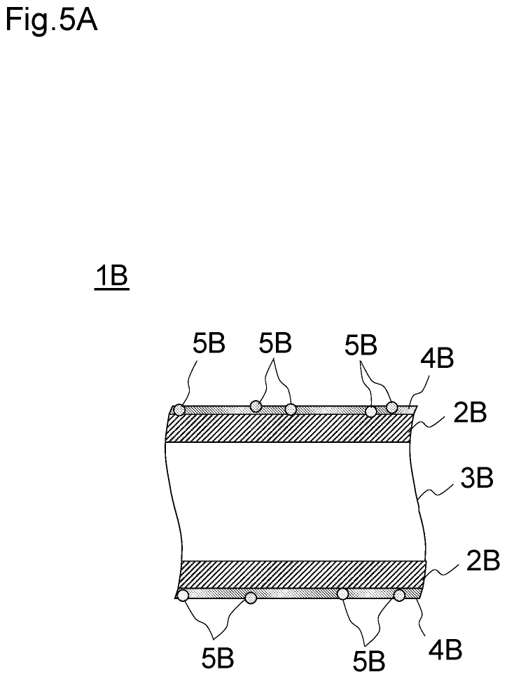

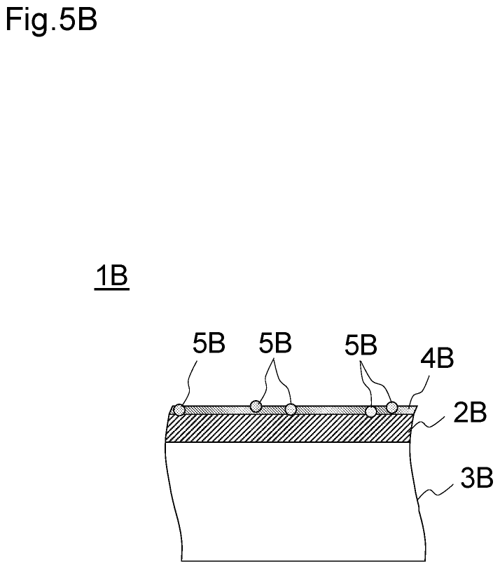

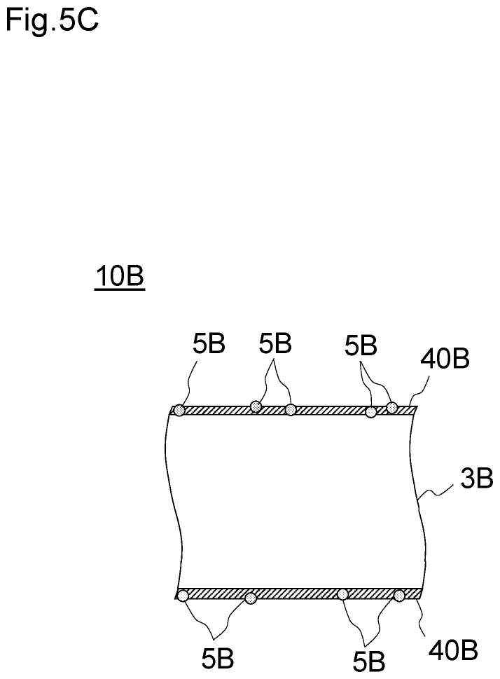

Hereinafter, an olefin film 1B (hereinafter, it is also simply referred to as a “film 1B”) as a second example will be described. The film 1B is configured to have a specific gravity as a whole of less than 1, and can be included in both the resin layer of the starting material according to the production method and the resin film produced by the production method. The film 1B includes a sheet-like core layer 3B having a first surface and a second surface, an adjacent layer 2B laminated on at least one of the first surface and the second surface of the core layer 3B, and a surface layer 4B laminated on the adjacent layer 2B. Therefore, the film 1B can take an aspect in which the adjacent layer 2B is laminated on both sides of the core layer 3B and the surface layer 4B is laminated on each adjacent layer 2B as shown in FIG. 5A, and an aspect in which the adjacent layer 2B is laminated on one surface of the core layer 3B and the surface layer 4B is laminated on the adjacent layer 2B as shown in FIG. 5B. Hereinafter, each member will be described in detail.

### 2-2-1. Core Layer

The core layer 3B contains a thermoplastic resin, and contains, for example, the propylene-based resin excluding the propylene elastomer, the petroleum resin, and an olefin elastomer. Also, the core layer 3B can contain a recycled raw material (P3). Since the outline of these resins has already been described in the first embodiment, redundant description will be omitted and additional matters will be described below.

### [Propylene-Based Resin]

The core layer 3B may contain one kind or two or more kinds among the above-described propylene-based resins. The deflection temperature under load (0.45 MPa) of the propylene-based resin is preferably 110° C. or lower, preferably 90° C. or lower. When the propylene-based resin is a mixed resin containing two or more propylene-based resins having different deflection temperatures under load, the deflection temperature under load of the propylene-based resin means an apparent deflection temperature under load calculated by summing the product of the deflection temperature under load of each propylene-based resin and the blending ratio (weight ratio).

When the core layer 3B does not contain the recycled raw material (P3), the core layer 3B contains the propylene-based resin (excluding the propylene-based elastomer) in an amount of preferably 50% by mass or more, preferably 75% by mass or less, more preferably 55% by mass or more, and more preferably 65% by mass or less, based on 100% by mass of the total of thermoplastic resins constituting the core layer 3B. That is, the core layer 3B contains the propylene-based resin in an amount of preferably 50% by mass to 75% by mass, more preferably 55% by mass to 65% by mass.

### [Petroleum Resin]

The softening point of the petroleum resin is as already described in the description of the film 1A. The petroleum resin preferably has a number average molecular weight of 700 or more and 1300 or less. When the petroleum resin has a number average molecular weight of less than 700, heat resistance of the film is lowered, and the petroleum resin component may be easily bled out to the surface in a high-temperature atmosphere. On the other hand, when the petroleum resin has a number average molecular weight of more than 1300, molding processability such as stretching processability may be deteriorated. The number average molecular weight of the petroleum resin can be confirmed by a gel permeation chromatography (GPC) method.

When the core layer 3B does not contain the recycled raw material (P3), the core layer 3B contains the petroleum resin in an amount of preferably 10% by mass or more and 35% by mass or less, more preferably 15% by mass or more and 30% by mass or less, based on 100% by mass of the total of thermoplastic resins constituting the core layer 3B. When the content is in this range, high shrinkability and high rigidity can be imparted to a heat shrinkable multilayer film. Also, when the content of the petroleum resin is equal to or less than the upper limit, it is possible to suppress a decrease in elongation at low temperature and peeling between layers.

### [Olefin Elastomer]

As the olefin elastomer, a propylene/α-olefin random copolymer elastomer is preferably used. Examples of other olefin elastomers include ethylene/α-olefin random copolymer elastomers. The α-olefin random copolymer elastomer is an elastomer in which a copolymerization component of an α-olefin having 3 or more carbon atoms is 15 mol % or more. Here, examples of the α-olefin include propylene, butene-1, pentene-1, hexene-1, octene-1, 4-methylpentene-1, and the like.

Examples of commercially available products of the olefin elastomer as described above include TAFMER (manufactured by Mitsui Chemicals, Inc.) and the like.

The olefin elastomer preferably has a Vicat softening temperature of 50° C. or higher and 75° C. or lower.

When the core layer 3B does not contain the recycled raw material (P3), the core layer 3B preferably contains the olefin elastomer in an amount of 15% by mass or less, based on 100% by mass of the total of thermoplastic resins constituting the core layer 3B.

When the core layer 3B contains the recycled raw material (P3), the core layer 3B contains the recycled raw material (P3) in an amount of preferably 1% by mass to 60% by mass, more preferably 5% by mass to 50% by mass, still more preferably 5% by mass to 40% by mass, based on 100% by mass of the total of thermoplastic resins constituting the core layer 3B. In addition, the core layer 3B in this case contains the propylene-based resin in an amount of preferably 30% by mass to 60% by mass, more preferably 35% by mass to 55% by mass, and contains the olefin elastomer in an amount of preferably 10% by mass or less. Furthermore, the core layer 3A in this case contains the petroleum resin in an amount of preferably 10% by mass to 35% by mass, more preferably 15% by mass to 25% by mass.

### [Thickness of Core Layer]

The core layer 3B has a thickness of, for example, preferably 15 μm or more and 40 μm or less, still more preferably 20 μm or more and 35 μm or less.

### 2-2-2. Adjacent Layer

The adjacent layer 2B contains a thermoplastic resin. The adjacent layer 2B can mainly contain a cyclic olefin-based resin as a thermoplastic resin, and can further contain an ethylene-based resin and a petroleum resin. Further, the adjacent layer 2B can contain a recycled raw material (P3). Since the outline of these resins has already been described in the first embodiment, redundant description will be omitted and additional matters will be described below.

### [Cyclic Olefin-Based Resin]

The cyclic olefin-based resin is preferably a cyclic olefin copolymer (COC). The cyclic olefin copolymer is obtained, for example, by copolymerizing an α-olefin and a cyclic olefin. The cyclic olefin is as described in the first embodiment. A surface layer 4B described later also contains a cyclic olefin-based resin. As a result, the interlayer adhesion strength between the adjacent layer 2B and the surface layer 4B is improved.

Preferred ranges of the density, glass transition temperature, and number average molecular weight measured by the GPC method of the cyclic olefin-based resin are as described in the description of the film 1A.

When the adjacent layer 2B does not contain the recycled raw material (P3), the adjacent layer 2B contains the cyclic olefin-based resin in an amount of preferably 55% by mass or more and 85% by mass or less, more preferably 60% by mass or more and 80% by mass or less, still more preferably 65% by mass or more and 75% by mass or less, based on 100% by mass of the total of thermoplastic resins constituting the adjacent layer 2B. When the content of the cyclic olefin-based resin is within the above range, the rigidity, heat shrinkage, and transparency of the film 1B can be improved.

[Ethylene-based resin]

The adjacent layer 2B particularly preferably contains the above-described linear low-density polyethylene resin. Also, the ethylene-based resin preferably has a density of 880 kg/m³ or more and 950 kg/m³ or less.

When the adjacent layer 2B does not contain the recycled raw material (P3), the adjacent layer 2B contains the linear low-density polyethylene resin in an amount of preferably 5% by mass or more and 25% by mass or less, still more preferably 10% by mass or more and 20% by mass or less, based on 100% by mass of the total of thermoplastic resins constituting the adjacent layer 2B.

### [Petroleum Resin]

The adjacent layer 2B may contain the petroleum resin as already described in the description of the core layer 3B. The adjacent layer 2B may contain the same petroleum resin as the core layer 3B, or may contain a different petroleum resin from the core layer 3B.

When the adjacent layer 2B does not contain the recycled raw material (P3), the adjacent layer 2B contains the petroleum resin in an amount of preferably 15% by mass or more and 35% by mass or less, still more preferably 20% by mass or more and 30% by mass or less, based on 100% by mass of the total of thermoplastic resins constituting the adjacent layer 2B.

When the adjacent layer 2B contains the recycled raw material (P3), the adjacent layer 2B contains the recycled raw material (P3) in an amount of preferably 1% by mass to 60% by mass, more preferably 5% by mass to 50% by mass, still more preferably 5% by mass to 40% by mass, based on 100% by mass of the total of thermoplastic resins constituting the adjacent layer 2B. Also, the adjacent layer 2B in this case contains the cyclic olefin-based resin in an amount of preferably 30% by mass to 60% by mass, more preferably 35% by mass to 55% by mass. In addition, the adjacent layer 2B in this case contains of the ethylene-based resin in an amount of preferably 5% by mass to 20% by mass, more preferably 10% by mass to 15% by mass. Furthermore, the adjacent layer 2B in this case contains the petroleum resin in an amount of preferably 10% by mass to 35% by mass, more preferably 15% by mass to 25% by mass.

### [Thickness]

The adjacent layer 2B has a thickness of preferably 2 μm or more and 5.5 μm or less, still more preferably 3 μm or more and 4.5 μm or less. Also, when the adjacent layer is provided, the ratio of the thicknesses of the core layer 3B and the adjacent layer 2B is preferably in the range of 9:1 to 5:1, more preferably in the range of 8:1 to 6:1 for the core layer/adjacent layer. By setting the thickness ratio within the above range, excellent shrinkage finish property can be realized as a heat shrinkable multilayer film.

### 2-2-3. Surface Layer

The surface layer 4B contains a thermoplastic resin and fine particles 5B held by the thermoplastic resin. As the thermoplastic resin, a cyclic olefin-based resin is preferable, and a cyclic olefin copolymer (COC) is more preferable. The surface layer 4B may contain the same cyclic olefin copolymer as the adjacent layer 2B, or may contain a cyclic olefin copolymer different from the adjacent layer 2B. The thermoplastic resin of the surface layer 4B has a thickness of preferably 0.2 μm or more and 5 μm or less, more preferably 0.4 μm or more and 1 μm or less. In particular, when a cyclic olefin copolymer is used as the thermoplastic resin, the thermoplastic resin of the surface layer 4B preferably has a thickness of 1 μm or less in order to maintain glossiness and transparency and to make sebum whitening less likely to occur when the thermoplastic resin comes into contact with sebum.

### 2-2-4. Fine Particles

The fine particles 5B held by the thermoplastic resin of the surface layer 4B mainly have a function of preventing blocking in which the films 1B are fused to each other and peeling becomes difficult. Examples of such fine particles 5B include those similar to those described for the fine particles of the film 1A. These may or may not be crosslinked, but are desirably crosslinked in order to enhance heat resistance of the fine particles 5B. The fine particles 5B are preferably acrylic resin fine particles, still more preferably polymethyl methacrylate crosslinked fine particles, particularly from the viewpoint of compatibility with the cyclic olefin-based resin and from the viewpoint of improving transparency of appearance.

The modal diameter of the fine particles 5B is preferably 1.2 times or more and 10 times or less, more preferably 1.2 times or more and 8 times or less the thickness of the thermoplastic resin of the surface layer 4B. That is, as shown in FIGS. 5A and 5B, the fine particles 5B are mainly held by the thermoplastic resin of the surface layer 4B, but a part of the fine particles 5B may protrude to the outside of the thermoplastic resin of the surface layer 4B or may enter the adjacent layer 2B. By setting the relationship between the thickness of the thermoplastic resin of the surface layer 4B and the modal diameter of the fine particles as described above, anti-blocking function of the film 1B can be suitably enhanced. When the modal diameter of the fine particles 5B is more than 10 times the thickness of the thermoplastic resin of the surface layer 4B, the fine particles 5B are likely to fall off, and printing failure during printing is likely to occur. When the modal diameter of the fine particles 5B is 8 times or less the thickness of the thermoplastic resin of the surface layer 4B, such a problem is less likely to occur, which is preferable. FIGS. 5A and 5B are schematic views for description, and do not necessarily reflect actual dimensions of the core layer 3B, the adjacent layer 2B, the surface layer 4B, and the fine particles 5B or distribution of the fine particles 5B.

The fine particles 5B have a modal diameter of preferably 6 μm or less, more preferably 5.5 μm or less, still more preferably 5 μm or less. Also, the fine particles 5B have a modal diameter of preferably 1.0 μm or more, more preferably 1.5 μm or more, still more preferably 3 μm or more. That is, the fine particles 5B have a modal diameter of preferably 1.0 μm to 6 μm, more preferably 1.5 μm to 5.5 μm, still more preferably 3 μm to 5 μm. When the fine particles 5B have a modal diameter of more than 6 μm, the transparency is reduced, and the fine particles easily fall off from the thermoplastic resin of the surface layer 4B. The modal diameter can be measured by a known laser diffraction/scattering method or the like. From the viewpoint of maintaining the transparency of the film 1B, the refractive index of the fine particles is preferably close to the refractive index of the thermoplastic resin constituting the surface layer 4B.

The content of the fine particles 5B is preferably 0.05 parts by mass or more, more preferably 0.1 parts by mass or more, with respect to 100 parts by mass of the resin component constituting the surface layer 4B. Also, the content of the fine particles 5B is preferably 0.5 parts by mass or less, more preferably 0.4 parts by mass or less. That is, the content of the fine particles 5B is preferably 0.05 parts by mass to 0.5 parts by mass, more preferably 0.1 parts by mass to 0.4 parts by mass. When the content is equal to or more than the lower limit, irregularities are formed on the surface of the film 1B, and the anti-blocking function of the film 1B can be improved. On the other hand, when the content is equal to or less than the upper limit, the transparency of appearance can be sufficiently maintained.

### 2-2-5. Thickness of Film

The entire film 1B excluding the fine particles 5B has a thickness of, for example, preferably 20 μm or more and 60 μm or less, more preferably 25 μm or more and 45 μm or less. In particular, the upper limit of the thickness is still more preferably 30 μm or less. When the thickness of the entire film 1B is within the above range, excellent heat shrinkage is obtained.

### 2-2-6. Anti-Blocking Function

The strength of blocking of the heat shrinkable multilayer film can be evaluated by a peeling adhesive strength in which two samples cut out from the heat shrinkable multilayer film are superposed on each other, a pressure is applied thereto, and the resultant is then pulled to 180° to peel off the two samples. The lower the peeling adhesive strength, the higher the anti-blocking function, and the higher the peeling adhesive strength, the more easily the heat shrinkable multilayer films are welded to each other, and the more easily blocking occurs. The peeling adhesive strength of the film 1B is preferably 1300 g/cm or less, more preferably 1100 g/cm or less, still more preferably 1000 g/cm or less.

### 2-2-7. Other Components

The core layer 3B, the adjacent layer 2B, and the surface layer 4B may contain additives such as an antioxidant, a heat stabilizer, an ultraviolet absorber, a light stabilizer, a lubricant, an antistatic agent, a flame retardant, an antibacterial agent, a fluorescent brightener, and a colorant as necessary.

### 2-2-8. Heat Shrinkage

When the film 1B is immersed in hot water at 100° ° C. for 10 seconds, then immersed in water at 20° ° C. for 10 seconds, and taken out, the film 1B has a heat shrinkage in the main shrinkage direction (TD direction) of preferably 64% or more and preferably 76% or less. Also, when the film 1B is immersed in hot water at 100° ° C. for 10 seconds and then immersed in water at 20° C. for 10 seconds, the film 1B has a heat shrinkage in the direction orthogonal to the main shrinkage direction (MD direction) of preferably 5% or more and preferably 20% or less. When the heat shrinkage is within the above-mentioned range, the film 1B does not cause problems such as shrinkage failure, and can be suitably used particularly as a heat shrinkable multilayer film to be attached to a container.

### 2-2-9. Production Method

The method for producing the film 1B is not particularly limited, but a method of simultaneously molding each layer by a co-extrusion method is preferable. When the co-extrusion method is co-extrusion by a T-die, the lamination method may be a feed block method, a multi-manifold method, or a method using these methods in combination.

Specifically, for example, there is a method in which raw materials constituting the core layer, the adjacent layer, and the surface layer described above are each charged into an extruder, extruded into a sheet shape by a die, cooled and solidified by a take-off roll, and then stretched uniaxially or biaxially. As a stretching method, for example, a roll stretching method, a tenter stretching method, or a combination thereof can be used. The stretching temperature is changed according to the softening temperature of the resin constituting the film 1B, shrinkage characteristics required for the film 1B, and the like, but is preferably 65° C. or higher, more preferably 70° C. or higher, and preferably 120° C. or lower, more preferably 115° C. or lower. Also, the stretch ratio is the same as that of the film 1A.

### 2-2-10. Other Aspects

In the above description, the core layer 3B, the adjacent layer 2B, and the surface layer 4B constitute the film 1B. However, as in the film 10B shown in FIG. 5C, the adjacent layer 2B may be omitted, and the outermost layer having the same configuration as that of the adjacent layer 2B may be laminated on at least one of the first surface and the second surface of the core layer 3B to constitute the surface layer 40B. In this case, the fine particles 5B may be added to the surface layer 40B. The surface layer 40B can also be formed only on one surface of the core layer 3B.

The surface layer 40B can have a thickness of, for example, 1 to 10 μm. In such a case, three layers are observed in the cross-sectional photograph of the film 10B.

### 2-2-11. Characteristics

According to the films 1B and 10B, a heat shrinkable multilayer film which hardly causes blocking is provided. Furthermore, when a cyclic olefin copolymer is used as the thermoplastic resin of the surface layer 4B, and has a thickness of 1 μm or less, a heat shrinkable multilayer film having high surface glossiness and transparency and hardly causing sebum whitening is provided. This improves the quality of printing on the heat shrinkable multilayer film. The films 1B and 10B are not limited thereto, but can be suitably used particularly as a base film of a packaging film and a shrink label attached to a metal can, a plastic container, or the like.

### 2-3. Third Olefin Film

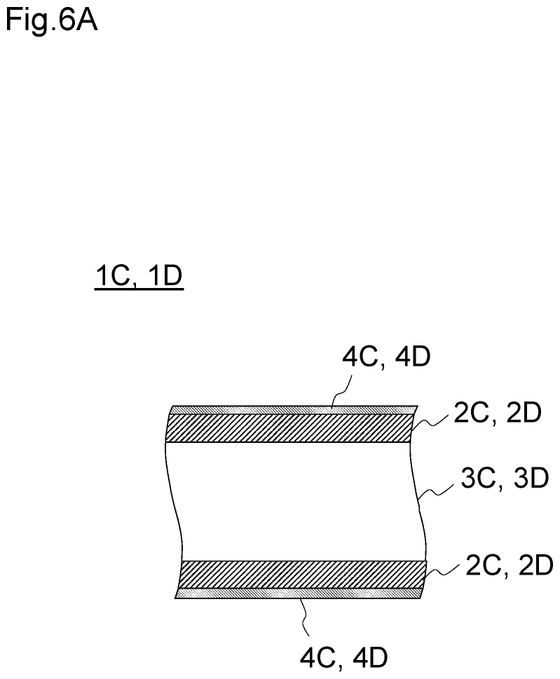

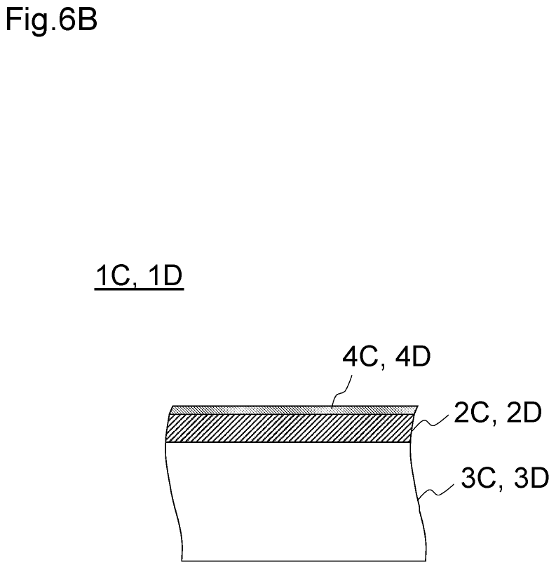

Hereinafter, an olefin film 1C (hereinafter, it is also simply referred to as a “film 1C”) as a third example will be described. The film 1C is configured to have a specific gravity as a whole of less than 1, and can be included in both the resin layer of the starting material according to the production method and the resin film produced by the production method. The film 1C includes a sheet-like core layer 3C having a first surface and a second surface, and an adjacent layer 2C laminated on at least one of the first surface and the second surface of the core layer 3C. Therefore, the film 1C can take an aspect in which the adjacent layer 2C is laminated on both surfaces of the core layer 3C as shown in FIG. 6A, and an aspect in which the adjacent layer 2C is laminated on one surface of the core layer 3C as shown in FIG. 6B. Further, the film 1C may include a surface layer 4C laminated on the adjacent layer 2C. Hereinafter, each member will be described in detail.

### 2-3-1. Core Layer

The core layer 3C contains a thermoplastic resin. More specifically, the core layer 3C mainly contains a propylene-based resin as a thermoplastic resin, and further contains a polypropylene having a long-chain branched structure. The core layer 3C can further contain a petroleum resin. Also, the core layer 3C can contain a recycled raw material (P3). Since the outline of these resins has already been described in the first embodiment, redundant description will be omitted and additional matters will be described below.

### [Propylene-Based Resin]

The deflection temperature under load (0.45 MPa) of the propylene-based resin is as already described in the description of the film 1B. The core layer 3C contains the above-described propylene-based resin in an amount of preferably 40% by mass or more and 80% by mass or less, and more preferably 50% by mass or more and 76% by mass or less, with respect to 100% by mass of the total of thermoplastic resins constituting the core layer 3C.

### [Long-Chain Branched Polypropylene]

The long-chain branched polypropylene is as already described in the description of the first embodiment and the film 1A. When the core layer 3C does not contain the recycled raw material (P3), the core layer 3C contains the long-chain branched polypropylene in an amount of preferably 3% by mass or more, more preferably 5% by mass or more, still more preferably 10% by mass or more, with respect to 100% by mass of the total of thermoplastic resins constituting the core layer 3C. On the other hand, from the viewpoint of maintaining appropriate heat shrinkage and securing transparency, the core layer 3C contains the above-described long-chain branched polypropylene in an amount of preferably less than 20% by mass and more preferably 15% by mass or less, with respect to 100% by mass of the resin component constituting the core layer 3C. That is, the core layer 3C contains the long-chain branched polypropylene in an amount of preferably 3% by mass or more and less than 20% by mass, more preferably 5% by mass or more and less than 20% by mass, still more preferably 10% by mass or more and 15% by mass or less.

### [Petroleum Resin]

The petroleum resin is as already described in the description of the first embodiment, and the softening point and the number average molecular weight of the petroleum resin are as already described in the description of the film 1B. When the core layer 3C does not contain the recycled raw material (P3), the core layer 3C contains the above-described petroleum resin, particularly the alicyclic petroleum resin, in an amount of preferably more than 20% by mass, more preferably 21% by mass or more, still more preferably 30% by mass or more, with respect to 100% by mass of the resin component constituting the core layer 3C.

### [Thickness of Core Layer]

The core layer 3C has a thickness of, for example, preferably 10 μm or more and 60 μm or less, more preferably 15 μm or more and 50 μm or less, still more preferably 15 μm or more and 40 μm or less.

Since the core layer 3C contains a relatively large amount of alicyclic petroleum resin, heat shrinkage and glossiness of the film 1C are improved. However, the alicyclic petroleum resin is likely to cause shrinkage return after heat shrinkage, and this causes loosening of the film 1C after heat shrinkage. When the core layer 3C contains long-chain branched polypropylene excellent in shape retention, the shrinkage return derived from the alicyclic petroleum resin is suppressed. As a result, the film 1C including the core layer 3C is less likely to be loosened after heat shrinkage while maintaining excellent heat shrinkage.

When the core layer 3C contains the recycled raw material (P3), the core layer 3C contains the recycled raw material (P3) in an amount of preferably 1% by mass to 60% by mass, more preferably 5% by mass to 50% by mass, still more preferably 5% by mass to 40% by mass, based on 100% by mass of the total of thermoplastic resins constituting the core layer 3C. In addition, the core layer 3C in this case contains the propylene-based resin in an amount of preferably 30% by mass to 60% by mass, more preferably 35% by mass to 55% by mass. In addition, the core layer 3C in this case contains the long-chain branched polypropylene in an amount of preferably 3% by mass to 15% by mass, more preferably 5% by mass to 10% by mass. Furthermore, the core layer 3C in this case contains the petroleum resin in an amount of preferably 10% by mass to 35% by mass, more preferably 15% by mass to 25% by mass.

### 2-3-2. Adjacent Layer

The adjacent layer 2C is a layer adjacent to at least one of the first surface and the second surface of the core layer 3C, and contains a thermoplastic resin. The adjacent layer 2C can mainly contain a cyclic olefin-based resin as a thermoplastic resin, and can further contain an ethylene-based resin. Also, when the adjacent layer 2C is disposed between the core layer 3C and the surface layer 4C, the adjacent layer 2C can contain a recycled raw material (P3).

The cyclic olefin-based resin is as described in the description of the film 1B. When the adjacent layer 2C does not contain the recycled raw material (P3), the adjacent layer 2C preferably contains the above-described cyclic olefin-based resin in an amount of 70% by mass or more with respect to 100% by mass of the thermoplastic resin constituting the adjacent layer 2C.

The adjacent layer 2C can contain the ethylene-based resin described in the first embodiment, and particularly preferably contains a linear low-density polyethylene resin. When the adjacent layer 2C does not contain the recycled raw material (P3), the adjacent layer 2C preferably contains the above-described ethylene-based resin in an amount of 30% by mass or less with respect to 100% by mass of the thermoplastic resin constituting the adjacent layer 2C.

When the adjacent layer 2C contains the recycled raw material (P3), the adjacent layer 2C contains the recycled raw material (P3) in an amount of preferably 1% by mass to 60% by mass, more preferably 5% by mass to 50% by mass, still more preferably 5% by mass to 40% by mass, based on 100% by mass of the total of thermoplastic resins constituting the adjacent layer 2C. Also, the adjacent layer 2C in this case contains the cyclic olefin-based resin in an amount of preferably 55% by mass to 80% by mass, more preferably 60% by mass to 70% by mass. Also, the core layer 3C in this case preferably contains the ethylene-based resin in an amount of 20% by mass or less.

### [Thickness of Adjacent Layer]

The thermoplastic resin of the adjacent layer 2C has a thickness of, for example, preferably 1 μm or more and 5 μm or less, and more preferably 1.5 μm or more and 4.5 μm or less.

### 2-3-3. Surface Layer

The film 1C may further include a surface layer 4C. The surface layer 4C is a layer adjacent to the adjacent layer 2C, is formed of a thermoplastic resin, and may further contain fine particles. As the thermoplastic resin, for example, a styrene resin, a polyester resin, an ethylene-based resin, a cyclic olefin-based resin, or the like, or a mixture of at least one of them can be used. Even when the surface layer 4C contains a styrene resin and a polyester resin, the main component of the film 1C is an olefin resin, and the film 1C is configured such that the specific gravity as a whole is less than 1.

### [Styrene Resin]

As the styrene resin, for example, a styrene-butadiene copolymer or a hydrogenated styrene thermoplastic elastomer can be used. Examples of commercially available products of the styrene resin include CLEAREN (manufactured by Denka Company Limited) and the like.

### [Polyester Resin]

The polyester resin is not particularly limited, but glycol-modified polyethylene terephthalate is preferable.

The ethylene-based resin is as described in the first embodiment. Also, the cyclic olefin-based resin is the same as that described for the adjacent layer 2C. When a cyclic olefin-based resin is used for the surface layer 4C, glossiness is increased, and surface properties can be improved. Furthermore, in the present embodiment, since the adjacent layer 2C also contains the cyclic olefin-based resin, the interlayer adhesion strength with the adjacent layer 2C is improved.

The surface layer 4C may further contain fine particles. The fine particles are as described in the description of the film 1A. The surface layer 4C contains the above-described fine particles in an amount of preferably 0.01 parts by weight or more and 0.10 parts by weight or less, still more preferably 0.03 parts by weight or more and 0.08 parts by weight or less, with respect to the total of thermoplastic resins constituting the surface layer 4C.

### [Thickness of Surface Layer]

The surface layer 4C has a thickness of, for example, preferably 0.1 μm or more and 3 μm or less, more preferably 0.2 μm or more and 2 μm or less, still more preferably 0.3 μm or more and 1 μm or less.

### 2-3-4. Thickness of Film

The entire film 1C has a thickness of, for example, preferably 15 μm or more and 80 μm or less, more preferably 20 μm or more and 70 μm or less, still more preferably 25 μm or more and 45 μm or less. When the thickness of the entire film 1C is within the above-mentioned range, excellent heat shrinkage is obtained, and loosening after heat shrinkage is effectively suppressed. Also, the ratio of the thicknesses of the core layer 3C and one layer of the adjacent layer 2C is preferably in the range of 9:1 to 5:1, more preferably in the range of 8:1 to 6:1 for the core layer/adjacent layer. Within the above range, excellent shrinkage finish property can be realized as a heat shrinkable multilayer film.

### 2-3-5. Other Components

The core layer 3C, the adjacent layer 2C, and the surface layer 4C may each contain additives such as an antioxidant, a heat stabilizer, an ultraviolet absorber, a light stabilizer, a lubricant, an antistatic agent, a flame retardant, an antibacterial agent, a fluorescent brightener, and a colorant as necessary.

### 2-3-6. Heat Shrinkage

When the film 1C is immersed in hot water at 100° C. for 10 seconds, then immersed in water at 20° C. for 10 seconds, and taken out, the film 1C has a heat shrinkage in the main shrinkage direction (TD direction) of preferably 64% or more and preferably 76% or less. Also, the heat shrinkage in the direction orthogonal to the main shrinkage direction (MD direction) when the film 1C is immersed in hot water at 100° C. for 10 seconds and then immersed in water at 20° ° C. for 10 seconds is preferably 5% or more and preferably 20% or less. When the heat shrinkage is within the above-mentioned range, the film 1C does not cause problems such as shrinkage failure, and can be suitably used particularly as a heat shrinkable multilayer film to be attached to a container.

### 2-3-7. Glossiness

Since the film 1C can be used as a base film of a heat shrinkable label, the film 1C preferably has a glossiness of appearance of 140 or more. The glossiness is glossiness at an incident angle of 45° measured using VG-2000 manufactured by Nippon Denshoku Industries Co., Ltd. by a method in accordance with ASTM D523.

### 2-3-8. Production Method

The method for producing the film 1C is not particularly limited, but the same method as the method for producing the film 1B described above can be adopted.

### 2-3-9. Characteristics

In the film 1C, the core layer 3C having the largest thickness and contributing most to the heat shrinkage as a whole contains a relatively large amount of an alicyclic petroleum resin excellent in heat shrinkage, and contains a long-chain branched polypropylene having high melt tension. This provides a heat shrinkable multilayer film that is excellent in heat shrinkability and is less likely to loosen even after heat shrinkage.

Further, in the film 1C, the adjacent layer 2C contains a cyclic olefin-based resin as a main component, thereby providing an appearance with high glossiness. Furthermore, when the adjacent core layers 3C contain an alicyclic petroleum resin having a structure similar to that of the cyclic olefin-based resin, the degree of interlayer adhesion with the core layer 3C is improved, and a heat shrinkable multilayer film having high interlayer adhesion strength is provided.

### 2-4. Fourth Olefin Film

Hereinafter, an olefin film 1D (hereinafter, it is also simply referred to as a “film 1D”) as a fourth example will be described. The film 1D is configured to have a specific gravity as a whole of less than 1, and can be included in both the resin layer of the starting material according to the production method and the resin film produced by the production method. The film 1D includes a sheet-like core layer 3D having a first surface and a second surface, and an adjacent layer 2D laminated on at least one of the first surface and the second surface of the core layer 3D. Therefore, the film 1D can take an aspect in which the adjacent layer 2D is laminated on both surfaces of the core layer 3D as shown in FIG. 6A, and an aspect in which the adjacent layer 2D is laminated on one surface of the core layer 3D as shown in FIG. 6B. Further, the film 1D may include a surface layer 4D laminated on the adjacent layer 2D. Hereinafter, each member will be described in detail.

### 2-4-1. Core Layer

The core layer 3D contains a thermoplastic resin. As the thermoplastic resin, for example, a propylene-based resin and a petroleum resin can be contained. Furthermore, the core layer 3D can contain a recycled raw material (P3). The propylene-based resin is as described in the description of the core layer 3B of the film 1B. The petroleum resin is as described in the first embodiment, and the core layer 3D particularly preferably contains an alicyclic petroleum resin.

The petroleum resin has a softening point of preferably 100° C. or higher and 150° C. or lower, more preferably 120° C. or higher and 130° C. or lower. When the softening point of the petroleum resin is within the above range, the heat shrinkage can be in a good range.

When the core layer 3D does not contain the recycled raw material (P3), the core layer 3D contains the propylene-based resin in an amount of preferably 65% by mass or more and 90% by mass or less, more preferably 70% by mass or more and 85% by mass or less, with respect to 100% by mass of the resin component constituting the core layer 3D. In addition, the core layer 3D contains the petroleum resin in an amount of preferably 10% by mass or more and 35% by mass or less, more preferably 15% by mass or more and 30% by mass or less, with respect to 100% by mass of the total of thermoplastic resins constituting the core layer 3D. When the content of the petroleum resin is in this range, high shrinkability and high rigidity can be imparted to a heat shrinkable multilayer film. Also, when the content of the petroleum resin is equal to or less than the upper limit, it is possible to suppress a decrease in elongation at low temperature and peeling between layers.

When the core layer 3D contains the recycled raw material (P3), the core layer 3D contains the recycled raw material (P3) in an amount of preferably 1% by mass to 60% by mass, more preferably 5% by mass to 50% by mass, still more preferably 5% by mass to 40% by mass, based on 100% by mass of the total of thermoplastic resins constituting the core layer 3D. Also, the core layer 3D in this case contains the propylene-based resin in an amount of preferably 55% by mass to 80% by mass, more preferably 60% by mass to 70% by mass. In addition, the core layer 3C in this case preferably contains the petroleum resin in an amount of 20% by mass or less.

### [Thickness of Core Layer]

The core layer 3D has a thickness of, for example, preferably 50% or more and 90% or less, more preferably 60% or more and 84% or less, still more preferably 70% or more and 80% or less, with respect to the thickness of the resin constituting the entire film 1D.

### 2-4-2. Adjacent Layer

The adjacent layer 2D mainly contains a cyclic olefin-based resin and a petroleum resin. In addition, an ethylene-based resin can be further contained. Further, when the adjacent layer 2D is disposed between the core layer 3D and the surface layer 4D, the adjacent layer 2D can contain a recycled raw material (P3). The petroleum resin is as described in the description of the core layer 3D. The cyclic olefin-based resin is as described in the description of the film 1B. The ethylene-based resin is as already described in the first embodiment.

The adjacent layer 2D contains the cyclic olefin-based resin in an amount of preferably 50% by mass or more and 90% by mass or less, more preferably 55% by mass or more and 85% by mass or less, still more preferably 60% by mass or more and 80% by mass or less, with respect to 100% by mass of the total of thermoplastic resins constituting the adjacent layer 2D. When the content of the cyclic olefin-based resin is within the above range, the rigidity, heat shrinkage, and transparency of the film 1D can be improved.

When the adjacent layer 2D does not contain the recycled raw material (P3), the adjacent layer 2D contains the ethylene-based resin in an amount of preferably 3% by mass or more and 30% by mass or less, more preferably 5% by mass or more and 25% by mass or less, still more preferably 8% by mass or more and 20% by mass or less, with respect to 100% by mass of the total of thermoplastic resins constituting the adjacent layer 2D. When the content of the ethylene-based resin is within the above range, sebum whitening of the cyclic olefin-based resin can be preferably suppressed, and sebum whitening resistance of the film 1D can be improved.

The adjacent layer 2D may contain the same petroleum resin as the core layer 3D or may contain a different petroleum resin. When the adjacent layer 2D does not contain the recycled raw material (P3), the adjacent layer 2D contains the petroleum resin in an amount of preferably 5% by mass or more and 35% by mass or less, more preferably 10% by mass or more and 30% by mass or less, still more preferably 15% by mass or more and 25% by mass or less, with respect to 100% by mass of the total of thermoplastic resins constituting the adjacent layer 2D.

When the adjacent layer 2D contains the recycled raw material (P3), the adjacent layer 2D contains the recycled raw material (P3) in an amount of preferably 1% by mass to 45% by mass, more preferably 5% by mass to 45% by mass, still more preferably 5% by mass to 40% by mass, based on 100% by mass of the total of thermoplastic resins constituting the adjacent layer 2D. Also, the adjacent layer 2D in this case contains the petroleum resin in an amount of preferably 5% by mass to 30% by mass, more preferably 5% by mass to 20% by mass. In addition, the adjacent layer 2D in this case contains the cyclic olefin-based resin in an amount of preferably 50% by mass to 90% by mass, more preferably 60% by mass or more to 80% by mass. When the adjacent layer 2D further contains an ethylene-based resin, the adjacent layer 2D contains the ethylene-based resin in an amount of preferably 3% by mass or more and 30% by mass or less, more preferably 5% by mass or more and 25% by mass or less, still more preferably 8% by mass or more and 20% by mass or less.

### [Thickness of Adjacent Layer]

The adjacent layer 2D has a thickness of, for example, preferably 5% or more and 25% or less, more preferably 8% or more and 20% or less, still more preferably 10% or more and 15% or less, with respect to the thickness of the resin constituting the entire film 1D.

### 2-4-3. Surface Layer

The surface layer 4D contains a thermoplastic resin. As the thermoplastic resin, for example, a styrene resin, a polyester resin, an ethylene-based resin, a cyclic olefin-based resin, or the like, or a mixture of at least one of them can be used. Even when the surface layer 4D contains a styrene resin and a polyester resin, the main component of the film 1D is an olefin resin, and the film 1D is configured such that the specific gravity as a whole is less than 1. Also, the surface layer 4D may further contain fine particles. By containing such fine particles, irregularities can be formed on the surface layer 4D. As a result, the fine particles function as an anti-blocking agent, and the strength of blocking of the film 1D can be reduced. The resin and the fine particles are as already described above.

The content of the fine particles is preferably 0.01 parts by weight or more and 0.10 parts by weight or less, still more preferably 0.03 parts by weight or more and 0.08 parts by weight or less, with respect to 100 parts by weight of the total of thermoplastic resins constituting the surface layer 4D.

### [Thickness of Surface Layer]

The surface layer 4D has a thickness of, for example, preferably 0.1% or more and 10% or less, more preferably 0.3% or more and 8% or less, still more preferably 0.5% or more and 3% or less, with respect to the thickness of the resin constituting the entire film 1D. By setting the thickness of the surface layer 4D within the above range, sebum whitening resistance of the film 1D can be improved.

### 2-4-4. Thickness of Film

The entire film 1C has a thickness of preferably 15 μm or more and 50 μm or less, more preferably 20 μm or more and 45 μm or less, still more preferably 25 μm or more and 40 μm or less.

### 2-4-5. Other Components

The core layer 3D, the adjacent layer 2D, and the surface layer 4D may contain additives such as an antioxidant, a heat stabilizer, an ultraviolet absorber, a light stabilizer, a lubricant, an antistatic agent, a flame retardant, an antibacterial agent, a fluorescent brightener, and a colorant as necessary.

### 2-4-6. Heat Shrinkage

When the film 1D is immersed in hot water at 70° C. for 10 seconds, then immersed in water at 20° C. for 10 seconds, and taken out, the film 1D has a heat shrinkage in the main shrinkage direction (TD direction) of preferably 5% or more and preferably 30% or less. Also, when the film 1D is immersed in hot water at 80° C. for 10 seconds, then immersed in water at 20° C. for 10 seconds, and taken out, the film 1D has a heat shrinkage in the main shrinkage direction of preferably 30% or more and preferably 60% or less. In addition, when the film 1D is immersed in hot water at 90° C. for 10 seconds, then immersed in water at 20° C. for 10 seconds, and taken out, the film 1D has a heat shrinkage in the main shrinkage direction of preferably 50% or more and preferably 70% or less. Moreover, when the film 1D is immersed in hot water at 98° ° C. for 10 seconds, then immersed in water at 20° C. for 10 seconds, and taken out, the film 1D has a heat shrinkage in the main shrinkage direction of preferably 60% or more and preferably 80% or less.

When the heat shrinkage is within the above-mentioned range, heat shrinkage corresponding to a relatively wide temperature range is possible, and the film can be suitably used as a heat shrinkable multilayer film.

### 2-4-7 Young's Modulus

Although the film 1D is not limited thereto, for example, the film 1D is molded into a cylindrical shape having a main shrinkage direction as a circumferential direction, and can be used as a base film for a label or a packaging material to be attached to a container such as a PET bottle or a metal can. Therefore, the film 1D is required to have certain rigidity so that the cylindrical body of a label or a packaging material does not break or collapse when being attached to the container. The Young's modulus of the film 1D in a direction orthogonal to the main shrinkage direction (MD direction) is preferably more than 1.3 (GPa). The Young's modulus of the film 1D in the main shrinkage direction is preferably more than 1.6 (GPa).

### 2-4-8. Production Method

The method for producing the film 1D is not particularly limited, but the same method as the method for producing the film 1B described above can be adopted.

### 2-4-9. Application of Film

The film 1D is excellent in heat shrinkability, rigidity, transparency, and resistance to sebum whitening. Therefore, application of the film 1D is not particularly limited, and the film 1D is suitably used, for example, as a base film for a heat shrinkable label and a package to be attached to a container such as a PET bottle or a metal can. Such a heat shrinkable label can be obtained by appropriately cutting the printed film 1D into a belt shape, for example. Sealing is performed with a solvent in a state where both end portions of the heat shrinkable label are superimposed on each other, the cylindrical label is covered on a container, and heat is applied to the container with a shrink tunnel to obtain a container to which the heat shrinkable label is attached. The films 1A to 1C can also be used as similar heat shrinkable labels, and can serve as starting materials for the production methods according to the first to third embodiments.

### 2-4-10. Characteristics

According to the film 1D of the present embodiment, the surface layer 4D has a thickness of 0.1% or more and 10% or less with respect to the thickness of the resin constituting the entire film 1D, and the adjacent layer 2D contains an appropriate amount of petroleum resin. This suppresses an undesirable effect on the appearance by whitening of a portion that has been in contact with a human hand after thermal shrinkage due to sebum. In addition, although the petroleum resin tends to reduce toughness and rigidity of the heat shrinkable multilayer film, the film 1D can maintain toughness and rigidity as a whole because the adjacent layer 2D contains an appropriate amount of petroleum resin and an appropriate amount of cyclic olefin-based resin.

### 3. Modifications

Although some embodiments of the present disclosure have been described above, the present disclosure is not limited to the above embodiments, and various modifications can be made without departing from the gist thereof. For example, the following modifications are possible. The gist of the following modifications can be appropriately combined.

### 3-1

In the second embodiment, the order of performing step S22 (cutting step) and step S23 (specific gravity separation step) may be changed. That is, step S23 may be performed after step S21 (ink layer separation step), step S21A (neutralization step), and step S21B (washing step), and then step S22 may be performed.

### 3-2

In the third embodiment, step S32 (specific gravity separation step) may be performed prior to step S31 (cutting step). That is, step S31, step S33 (ink layer separation step), and the like may be performed after step S32. In this case, either step S31 or step S33 may be performed first. When step S32 is followed by step S33, step S33A (neutralization step), and step S33B (washing step), the order of subsequent step S31 and step S33C (drying step) can also be appropriately changed.

### 3-3

In the first to third embodiments and the modifications thereof, the neutralization step, the washing step, and the drying step may be appropriately omitted, or may be appropriately additionally performed between the steps. Also, in the first to third embodiments and the modifications thereof, when a PET bottle is contained in the starting material, selection of a raw material derived from the film label may be appropriately additionally performed between the steps, in addition to the above timing.

### 3-4

When the resin film prepared in the extrusion molding step has a multilayer structure having two or more layers, the extrusion molding step may include forming an intermediate layer between the first layer and the second layer different from the first layer, the intermediate layer being composed of a resin composition that easily swells or dissolves in water or an alkaline aqueous solution. In this case, the intermediate layer may be co-extruded with the first layer and the second layer, or the first layer and the second layer may be separately extrusion molded, a resin composition for forming the intermediate layer may be laminated on the surface of any one of the layers, and the first layer and the second layer may be laminated so as to sandwich the intermediate layer.

### EXAMPLES

Hereinafter, examples of the present disclosure will be described in detail. However, the present disclosure is not limited to these examples.

### Experiment 1. Study on Resin Film Containing Recycled Raw Material

### <1-1. Preparation of Examples and Reference Examples>

As raw materials constituting a core layer and adjacent layers laminated adjacent to both surfaces of the core layer, the raw materials shown in Table 1 were blended in the proportions (the unit is % by mass) shown in Table 1 to prepare resin compositions constituting the core layer and the adjacent layers. In Example 1, a recycled raw material having a specific gravity of less than 1 was blended in the raw materials constituting the core layer. This recycled raw material is a material obtained from a resin film produced once as an olefin film, and is known to contain polypropylene, polyethylene, a cyclic olefin copolymer (COC), and a petroleum resin. Raw materials other than the recycled raw material are commercially available unrecycled raw materials, and the following products are used.
COC1: TOPAS (registered trademark), manufactured by Polyplastics Co., Ltd.
COC2: TOPAS (registered trademark), manufactured by Polyplastics Co., Ltd.
LLDPE: Evolue (registered trademark), manufactured by Prime Polymer Co., Ltd.
Random PP copolymer: Adsyl (registered trademark), manufactured by LyondellBasell
Petroleum resin: ARKON, manufactured by Arakawa Chemical Industries, Ltd.

TABLE 1

| | | Reference | |
|---|---|---|---|
| | | Example 1 | Example 1 |
| Adjacent | COC1 | 30 | 30 |
| layer | COC2 | 30 | 30 |
| | LLDPE | 40 | 40 |
| Core | Random PP copolymer | 75 | 45 |
| layer | Petroleum resin | 25 | 15 |
| | Recycled raw material | 0 | 40 |

Each of the resin compositions constituting the core layer and the adjacent layers was melted, co-extruded from a T-die, and cooled and solidified with a roll cooled to 30° ° C. to prepare an unstretched resin film. This unstretched resin film was stretched 5 times with a tenter stretching machine at a temperature of 90° ° C. to prepare a resin film having a three-layer structure. The thickness of the entire resin film, the thickness of the core layer, and the thickness of the core layer were common in Example 1 and Reference Example 1. Also, the resin film according to Reference Example 1 has a specific gravity of 0.94. The resin film according to Example 1 has a specific gravity of less than 1.

### 1-2. Evaluation

The resin films according to the above Examples and Reference Examples were evaluated as follows.

### 1-2-1. Heat Shrinkage

Three samples each having a size of 100 mm in the main shrinkage (TD) direction and 100 mm in the sub shrinkage (MD) direction were cut out from arbitrary portions of the resin films according to Example 1 and Reference Example 1. Each sample was immersed in hot water for 10 seconds, then taken out, immersed in water at 20° C. for 10 seconds, and taken out again. Thereafter, length L (mm) of each sample in the TD direction was measured, and the shrinkage (%) in the TD direction was each calculated according to the following formula (1). For the resin films according to Example 1 and Reference Example 1, the average value of the shrinkage of each sample was taken as the heat shrinkage.

Shrinkage (%)={(100−L)/100}×100 (1)

As the hot water, water at 70° ° C., 80° ° C., and 90° ° C. was used, and for each of them, three samples were prepared, and the shrinkage was calculated.

### 1-2-2. Natural Shrinkage

Three samples each having a size of 100 mm in the MD direction×100 mm in the TD direction were cut out from arbitrary portions of the resin films according to Example 1 and Reference Example 1. Each sample was allowed to stand in a low temperature incubator (manufactured by IL-82 Yamato Scientific Co., Ltd.) adjusted to 40° C. for 7 days, and then length L (mm) of each sample in the TD direction was measured. For each sample, the natural shrinkage (%) in the TD direction was calculated according to the same formula as the shrinkage. For the resin films according to Example 1 and Reference Example 1, the average value of the natural shrinkage of each sample was taken as the natural shrinkage.

### 1-2-3. Young's Modulus

Three samples each having a size of 250 mm in the MD direction×5 mm in the TD direction and three samples each having a size of 250 mm in the TD direction×5 mm in the MD direction were cut out from arbitrary portions of the resin films according to Example 1 and Reference Example 1. The Young's moduli (GPa) of these samples in the MD direction and the TD direction were each measured by a method in accordance with ASTM D882 using Strograph (VE-1D manufactured by Toyo Seiki Seisaku-sho, Ltd.).

### 1-3. Evaluation Results

The evaluation results are as shown in Table 2 below.

TABLE 2

| | | | Reference | |
|---|---|---|---|---|
| | | | Example 1 | Example 1 |
| Young's modulus (MD/TD) (GPa) | | | 1.2/1.8 | 1.4/2.1 |
| | Shrinkage (%) | 70° C. | 13 | 13 |
| | | 80° C. | 45 | 46 |
| | | 90° C. | 60 | 63 |

| | | |
|---|---|---|
| Natural shrinkage (%) | 2.7 | 2 |

As can be seen from Table 2, in Example 1 containing a recycled raw material, the Young's modulus was higher in both the MD direction and the TD direction and the rigidity was improved as compared with Reference Example 1. Further, in Example 1, the shrinkage at 80° C. and 90° C. was slightly improved as compared with Reference Example 1, whereas the natural shrinkage was suppressed, and preferable performance was exhibited as compared with Reference Example 1.

### Experiment 2. Study of Olefin Film 1A

### <2-1. Preparation of Examples and Comparative Examples>

### [Raw Materials]

As raw materials constituting a core layer and adjacent layers laminated adjacent to both surfaces of the core layer, the raw materials shown in Table 3 were blended in the proportions (the unit is % by mass) shown in Table 3 to prepare resin compositions constituting the adjacent layers and the core layer according to Examples 2 to 7 and Comparative Examples 1 and 2, respectively. As raw materials in Table 3, the following materials were used.
COC1: Ethylene-norbornene copolymer resin (density 1010 Kg/m³, MVR 6.0 cm³/10 min, glass transition temperature 78° C.)
COC2: Ethylene-norbornene copolymer resin (density 1010 Kg/m³, MVR 6.0 cm³/10 min, glass transition temperature 65° C.)
LLDPE1: Linear low-density polyethylene (density: 915 Kg/m³, MFR 1.0 g/10 min, Vicat softening point 98° C.)
LLDPE2: Linear low-density polyethylene (density: 913 Kg/m³, MFR 2.0 g/10 min, Vicat softening point 96° C.)
Petroleum resin (softening point 125° C.)
Polypropylene random copolymer (random PP) (MFR 5.5 g/10 min, Vicat softening point 111° C.)
Long-chain branched polypropylene (long-chain branched PP) (density 900 Kg/m³, MFR 2.8 g/10 min, deflection temperature under load (0.45 MPa)) 120° ° C.

TABLE 3

| | | | | | | | | Com- | |
|---|---|---|---|---|---|---|---|---|---|
| | | | | | | | | parative | |
| | | Examples | | | | | | Examples | |
| | | 2 | 3 | 4 | 5 | 6 | 7 | 1 | 2 |
| Adjacent | COC1 (Tg: 78° C.) | 30 | 30 | 0 | 0 | 0 | 30 | 40 | 30 |
| layer | COC2 (Tg: 65° C.) | 30 | 30 | 60 | 60 | 60 | 30 | 40 | 30 |
| | LLDPE1 | 20 | 20 | 20 | 20 | 20 | 30 | 20 | 40 |
| | Petroleum resin | 20 | 20 | 20 | 20 | 20 | 10 | 0 | 0 |
| Core | Random PP | 55 | 65 | 65 | 80 | 90 | 50 | 55 | 55 |
| layer | Long-chain | 10 | 0 | 0 | 0 | 0 | 0 | 10 | 10 |
| | branched PP | | | | | | | | |
| | Petroleum resin | 20 | 20 | 20 | 20 | 10 | 40 | 20 | 20 |
| | COC2 | 5 | 5 | 10 | 0 | 0 | 5 | 5 | 5 |
| | COC1 | 5 | 5 | 0 | 0 | 0 | 0 | 5 | 5 |
| | LLDPE2 | 5 | 5 | 5 | 0 | 0 | 5 | 5 | 5 |

| Thickness ratio | 1/5/1 |
|---|---|
| (adjacent layer/ | |
| core layer/adjacent layer) | |

### [Extrusion Molding]

Each of the obtained resin compositions was charged into an extruder, the adjacent layer was melted at a barrel temperature of 210° C. and the core layer was melted at a barrel temperature of 180° C., extruded from a T-die, and cooled and solidified with a roll cooled to 30° ° C. to prepare an unstretched sheet having a three-layer structure in which the adjacent layers were laminated on both surfaces of the core layer. Each unstretched sheet was stretched 5 times in the TD direction with a tenter stretching machine at a temperature of 90° ° C. to prepare a heat shrinkable film having a total thickness of 40 μm and a thickness ratio of each layer of 1:5:1. These heat shrinkable films have a specific gravity of less than 1.

### 2-2. Evaluation

The heat shrinkable films according to Examples 2 to 7 and Comparative Examples 1 and 2 were evaluated as follows.

### 2-2-1. Young's Modulus

Measurement samples were cut out from arbitrary portions of the heat shrinkable films according to Examples 2 to 7 and Comparative Examples 1 and 2 in the same manner as in the evaluation of Young's modulus in Experiment 1, and the Young's moduli (GPa) in the MD direction and the TD direction were each measured in the same procedure as in Experiment 1.

### 2-2-2. Heat Shrinkage

Samples for measurement having a size of 100 mm in length×100 mm in width were cut out from arbitrary portions of the heat shrinkable films according to Examples 2 to 7 and Comparative Examples 1 and 2. For each sample, an experiment was performed in hot water at 70° ° C., 80° C., and 90° ° C. in the same procedure as in the evaluation of heat shrinkage in Experiment 1, and the heat shrinkage was calculated according to formula (1).

### 2-2-3. Natural Shrinkage

Three samples for measurement each having a size of 100 mm in length×100 mm in width were cut out from arbitrary portions of the heat shrinkable films according to Examples 2 to 7 and Comparative Examples 1 and 2. For each sample, the same experiment as the evaluation of natural shrinkage in Experiment 1 was performed to determine the natural shrinkage of the heat shrinkable film for each sample.

### 2-2-4. Haze Before Shrinkage

Samples of the same size were cut out from the heat shrinkable films according to Examples 2 to 7 and Comparative Examples 1 and 2, and the haze (%) was measured using a haze meter (NDH5000 manufactured by Nippon Denshoku Industries Co., Ltd.) according to JIS K7136.

### 2-2-5. Sebum Whitening Amount

Samples having a size of 150 mm in length×250 mm in width (the MD direction of the film is defined as a longitudinal direction, and the TD direction is defined as a lateral direction) were cut out from the heat shrinkable films according to Examples 2 to 7 and Comparative Examples 1 and 2, and two marked lines in the longitudinal direction at intervals of 150 mm in the lateral direction were drawn. Sebum was attached to each sample by touching between marked lines of each sample several times with a finger to which sebum around the nose was attached. Subsequently, each sample with sebum was attached to a jig, immersed in hot water at 80° C. for 7 seconds, and shrunk so that the interval between marked lines was 105 mm. The state of each sample after shrinkage was visually confirmed, and evaluated as level 1, level 2, and level 3 in the ascending order of the degree of sebum whitening. That is, level 1 indicates having relatively high grease resistance, level 2 indicates having acceptable grease resistance, and level 3 indicates having grease resistance below the standard.

### 2-2-6. Loosening Amount

Rectangular samples of the same size were cut out from the heat shrinkable films according to Examples 2 to 7 and Comparative Examples 1 and 2. Both ends of each sample in the MD direction were sealed to prepare a cylindrical body having the same length and inner diameter. A cylindrical plastic container having a common configuration and a common dimension (outer circumference 280 mm) was covered with each of the prepared cylindrical bodies, and then passed through a hot air shrink tunnel at 100° C., so that the cylindrical body is thermally shrunk and attached to the container. Immediately after the heat shrinkage, it was confirmed that all the cylindrical bodies adhered to the container. This container with a cylindrical body was allowed to stand at an air temperature of 20° ° C. for 24 hours, then the cylindrical body was removed from the container, and the circumferential length (that is, the length in the TD direction) of the cylindrical body was measured. The difference between the circumferential length of the cylindrical body and the outer periphery of the container was defined as a loosening amount (mm), and evaluation A was given when the loosening amount was less than 1.0 mm, and evaluation B was given when the loosening amount was 1.0 mm or more and less than 1.5 mm. That is, evaluation A indicates that return after heat shrinkage is sufficiently suppressed, and evaluation B indicates that return after heat shrinkage is within an acceptable range.

### 2-3. Results

The results of Experiment 2 are shown in Table 4.

TABLE 4

| | | | | | | | | Comparative | |
|---|---|---|---|---|---|---|---|---|---|
| | | Examples | | | | | | Examples | |
| | | 2 | 3 | 4 | 5 | 6 | 7 | 1 | 2 |
| Young's modulus | | 1.5/2.1 | 1.4/1.9 | 1.4/1.9 | 1.4./1.9 | 1.3/1.8 | 1.5/2.2 | 1.6/2.2 | 1.3/1.8 |
| (Gpa) (MD/TD) | | | | | | | | | |
| Shrinkage (%) | 70° C. | 13 | 12 | 19 | 17 | 15 | 12 | 12 | 16 |
| | 80° C. | 45 | 44 | 45 | 44 | 43 | 45 | 45 | 45 |
| | 90° C. | 60 | 59 | 60 | 59 | 53 | 61 | 60 | 58 |

| | | | | | | | | |
|---|---|---|---|---|---|---|---|---|
| Natural shrinkage (%) | 2.3 | 2.5 | 3.2 | 3.4 | 3.8 | 2.3 | 2 | 3.1 |
| Sebum whitening amount | 1 | 1 | 1 | 1 | 1 | 1 | 3 | 1 |
| Haze (%) | 3.3 | 3.2 | 3.2 | 3 | 3 | 3.5 | 3 | 4.4 |
| Loosening amount | A | B | B | B | B | B | B | B |

As shown in Table 4, no significant difference was seen between Examples and Comparative Examples in terms of Young's modulus (rigidity), heat shrinkage, natural shrinkage, and loosening amount. However, Comparative Examples 1 and 2 in which no petroleum resin was contained in the surface layer resulted in inferior appearance quality to Examples 2 to 7. In Comparative Example 1, it is considered that sebum whitening could not be sufficiently suppressed because the adjacent layer contained a relatively large amount of cyclic olefin-based resin while containing no petroleum resin. Also, in Comparative Example 2, it is considered that transparency (haze) was deteriorated because the adjacent layer contained a relatively large amount of ethylene-based resin while containing no petroleum resin. In Examples 2 to 7, it was shown that when the adjacent layer contained a petroleum resin, sebum whitening and deterioration of transparency were effectively suppressed. In addition, in Examples 1 and 2 in which the adjacent layer contained two kinds of cyclic olefin-based resins, the heat shrinkage was not inferior to other examples, but the natural shrinkage was more preferable. It has been confirmed that Example 2 containing a petroleum resin in the adjacent layer and the core layer and further containing a long-chain branched polypropylene in the core layer exhibits particularly preferable performance with a smaller loosening amount after heat shrinkage than the other examples.

### Experiment 3. Study of Olefin Film 1B

### 3-1. Preparation of Examples and Comparative Examples

As described below, heat shrinkable multilayer films according to Examples 8 to 15 and Comparative Examples 3 and 4 were prepared. Examples 8 to 14 and Comparative Examples 3 and 4 had a five-layer structure shown in FIG. 5A. Also, Example 15 had a three-layer structure shown in FIG. 5C. That is, the heat shrinkable multilayer film according to Example 15 included the core layer and the surface layer that also served as the adjacent layer. These heat shrinkable multilayer films have a specific gravity of less than 1.

The components shown in Table 5 were used as raw materials constituting the core layer, the adjacent layer, and the surface layer, and these were mixed at the ratio shown in Table 5 to obtain raw material compositions constituting the core layer, the adjacent layer, and the surface layer according to Examples 8 to 14 and Comparative Examples 3 and 4. APEL APL6509T (manufactured by Mitsui Chemicals, Inc.) was used as the cyclic olefin-based resin of the surface layer and the adjacent layer. Evolue SP1020 (manufactured by Prime Polymer Co., Ltd.) was used as the linear low-density ethylene-based resin (LLDPE) of the adjacent layer, and ARKON P125 (manufactured by Arakawa Chemical Industries, Ltd.) was used as the petroleum resin. TAFMER A4070S (manufactured by Mitsui Chemicals, Inc.) was used as the olefin elastomer of the core layer, NOVATEC FW3GT (manufactured by Japan Polypropylene Corporation) was used as the propylene-based resin, and ARKON P125 (manufactured by Arakawa Chemical Industries, Ltd.) was used as the petroleum resin. As the fine particles, Art Pearl J-4PY (manufactured by Negami Chemical Industrial Co., Ltd.) was used in Examples 8 to 12 and Comparative Examples 3 and 4, and Art Pearl J-6PF (manufactured by Negami Chemical Industrial Co., Ltd.) was used in Examples 13 and 14. For reference, the refractive index of the cyclic olefin-based resin was 1.54, and the refractive index of the fine particles was 1.5.

In Example 15, the same cyclic olefin-based resin, linear low-density ethylene-based resin, and petroleum resin as those in other Examples and Comparative Examples were used for the surface layer, and NOVATEC (manufactured by Japan Polyethylene Corporation) was also used as a low-density ethylene resin (LDPE). In Example 15, an olefin elastomer was not used for the core layer. Also, Art Pearl SE-006T was used as the fine particles.

Subsequently, the raw material compositions constituting the core layer, the adjacent layer, and the surface layer were melted using another extruder at a barrel temperature of 180° C. for the core layer, a barrel temperature of 210° C. for the adjacent layer, and a barrel temperature of 210° C. for the surface layer, extruded from a T-die, and cooled and solidified with a roll cooled to 30° C. to prepare an unstretched sheet. This unstretched film was stretched 5 times in the TD direction with a tenter stretching machine at a temperature of 90° ° C. to prepare a heat shrinkable multilayer film. The thickness (μm) of each layer, the addition amount (parts by mass) of the fine particles, and the modal diameter (μm) of the added fine particles are shown in Table 6. The thickness of the layer is the thickness of the thermoplastic resin constituting the layer.

TABLE 5

| | | Examples 8 to 14, | | |
|---|---|---|---|---|
| | | Comparative | | Example |
| | | Examples 3 and 4 | | 15 |
| Surface | Cyclic olefin- | 100 | | — |
| layer | based resin | | | |
| Adjacent | Cyclic olefin- | 70 | Adjacent | 68.9 |
| layer | based resin | | layer | |
| | Petroleum resin | 20 | | — |
| | LLDPE | 10 | | 26.4 |
| | LDPE | — | | 4.7 |
| Core | Olefin elastomer | 10 | Core | — |
| layer | Propylene-based | 65 | layer | 75 |
| | resin | | | |
| | Petroleum resin | 25 | | 25 |

The unit of each material constituting the surface layer, the adjacent layer, and the core layer is % by mass.

TABLE 6

| | | | Modal | |
|---|---|---|---|---|
| | | | diameter/ | |
| | Modal | Addition | thickness | |
| | diameter | amount | of resin | |
| | of fine | of fine | of surface | Thickness |
| | particles | particles | layer | of each layer |
| Example 8 | 2 | 0.1 | 4/1 | 0.5/4.5/30/4.5/0.5 |
| Example 9 | 2 | 0.01 | 4/1 | 0.5/4.5/30/4.5/0.5 |
| Example 10 | 2 | 0.05 | 4/1 | 0.5/4.5/30/4.5/0.5 |
| Example 11 | 2 | 0.05 | 3/1 | 0.67/4.33/30/4.33/0.67 |
| Example 12 | 2 | 0.05 | 2/1 | 1/4/30/4/1 |
| Example 13 | 4 | 0.05 | 4/0.5 | 0.5/4.5/30/4.5/0.5 |
| Example 14 | 4 | 0.3 | 4/0.5 | 0.5/4.5/30/4.5/0.5 |
| Example 15 | 6 | 0.05 | 6/5 | 5/40/5 |
| Comparative | 2 | 0.05 | 1/1 | 2/3/30/3/2 |
| Example 3 | | | | |
| Comparative | 2 | 0.05 | 2/3 | 3/2/30/2/3 |
| Example 4 | | | | |

### 3-2. Evaluation

The following evaluations were performed for Examples 8 to 15 and Comparative Examples 3 and 4.

### 3-2-1. Haze

Samples of the same size were cut out from the heat shrinkable multilayer films according to Examples 8 to 15 and Comparative Examples 3 and 4, and the haze (%) was measured according to JIS K7136. In the evaluation, when the haze was 4% or less, it was determined as “1” in which the appearance was good, and when the haze was more than 4%, it was determined as “0” in which there was a problem in appearance.

### 3-2-2. Blocking

Two measurement samples each having a size of 100 mm in length×30 mm in width (the TD direction of the film is defined as the longitudinal direction, and the MD direction is defined as the lateral direction) were cut out from arbitrary portions of each of the heat shrinkable multilayer films according to Examples 8 to 15 and Comparative Examples 3 and 4. Next, the two measurement samples were overlapped on the same plane with an area of 40 mm in length×30 mm in width. Subsequently, the overlapping measurement sample was sandwiched between two glass plates, and a weight of 5 kg was placed on the overlapping portion of the samples. The samples thus set were placed in a thermostatic bath at 40° C. and left for 48 hours. Thereafter, the samples taken out from the thermostatic bath were set in a peeling tester (Peeling TESTER HEIDON-17 manufactured by Shinto Scientific Co., Ltd.), and pulled to 180° at a tensile speed of 200 mm/min, and the peeling adhesive strength at which the two samples were peeled was defined as the blocking strength.

The blocking strength was evaluated as “1” in which the anti-blocking function is in the acceptable range when the blocking strength was 1300 g/cm or less, as “2” in which the anti-blocking function is in the good range when the blocking strength was 1100 g/cm or less, and as “3” in which the anti-blocking function is in the better range when the blocking strength was 1000 g/cm or less. The blocking strength was evaluated as “0” in which blocking to an extent that causes a problem easily occurs when the blocking strength was more than 1300 g/cm.

### 3-3. Evaluation Results

The results of Experiment 3 are shown in Table 7.

TABLE 7

| | Exam- | Exam- | Exam- | Exam- | Exam- | Exam- | Exam- | Exam- | Com- | Com- |
|---|---|---|---|---|---|---|---|---|---|---|
| | ple | ple | ple | ple | ple | ple | ple | ple | parative | parative |
| | 8 | 9 | 10 | 11 | 12 | 13 | 14 | 15 | Example 3 | Example 4 |
| Haze (%) | 3.5 | 2.8 | 3.2 | 3.2 | 3.2 | 3.5 | 3.8 | 5.2 | 3.8 | 4.33 |
| Haze evaluation | 1 | 1 | 1 | 1 | 1 | 1 | 1 | 0 | 1 | 0 |
| Blocking strength | 820 | 850 | 800 | 950 | 1100 | 800 | 750 | 840 | 1500 | 1800 |
| (g/cm) | | | | | | | | | | |
| Evaluation of anti- | 3 | 3 | 3 | 3 | 2 | 3 | 3 | 3 | 0 | 0 |
| blocking function | | | | | | | | | | |

According to the above results, the blocking strength of Examples 8 to 15 was all 1100 g/cm or less, and a good anti-blocking function was exhibited (evaluation “2”). Particularly, in Examples 8 to 11 and 13 to 15, a better anti-blocking function was exhibited (evaluation “3”). On the other hand, in Comparative Examples 3 and 4, the anti-blocking function was not exhibited (evaluation “0”). As a result, it has been confirmed that the anti-blocking function is improved by setting the modal diameter of the fine particles to 1.2 times to 10 times the thickness of the thermoplastic resin of the surface layer.

In Examples 8 to 14, the haze was also suppressed to be low (evaluation “1”). On the other hand, in Example 15, the haze was high (evaluation “0”), which is considered to be because the thickness of the thermoplastic resin of the surface layer was relatively large, as in Comparative Example 4.

### Experiment 4. Study of Olefin Film 1C

### 4-1. Preparation of Examples and Comparative Examples

As described below, heat shrinkable multilayer films according to Examples 16 to 22 and Comparative Examples 5 to 7 were prepared. As shown in FIG. 4, the heat shrinkable multilayer films according to Examples 16 to 21 and Comparative Examples 5 and 6 had a three-layer structure including a core layer and adjacent layers laminated on both surfaces of the core layer, with the surface layer of FIG. 6A omitted. On the other hand, as shown in FIG. 1, the heat shrinkable multilayer films according to Example 22 and Comparative Example 7 had a five-layer structure including a core layer, adjacent layers laminated on both surfaces of the core layer, and surface layers laminated on each adjacent layer. These heat shrinkable multilayer films have a specific gravity of less than 1.

The components shown in Table 8 were used as raw materials constituting the core layer, the adjacent layer, and the surface layer, and these were mixed at the ratios shown in Table 8 to obtain raw material compositions constituting the core layer, the adjacent layer, and the surface layer according to Examples 16 to 22 and Comparative Examples 5 to 7. A propylene copolymer was used as a main component of the core layer. Also, WAYMAX (manufactured by Japan Polypropylene Corporation) was used as the long-chain branched polypropylene of the core layer. ARKON P125 (manufactured by Arakawa Chemical Industries, Ltd.) was used as the alicyclic petroleum resin of the core layer. In Examples 20 and 21, an aromatic petroleum resin was used instead of the alicyclic petroleum resin.

Linear low-density polyethylene was used as the ethylene-based resin of the adjacent layer. Also, a cyclic olefin copolymer (COC) was used as the cyclic olefin-based resin of the adjacent layer. Furthermore, a surface layer was also formed using a similar cyclic olefin copolymer (COC).

Subsequently, the raw material compositions constituting the core layer, the adjacent layer, and the surface layer were melted using another extruder at a barrel temperature of 180° C. for the core layer, a barrel temperature of 210° ° C. for the adjacent layer, and a barrel temperature of 210° C. for the surface layer, extruded from a T-die, and cooled and solidified with a roll cooled to 30° C. to prepare an unstretched sheet. This unstretched film was stretched 5 times in the TD direction with a tenter stretching machine at a temperature of 90° ° C. to each prepare a heat shrinkable multilayer film.

The heat shrinkable multilayer films according to Examples 16 to 21 and Comparative Examples 5 to 6 each had 32 μm in thickness of the core layer and 4 μm in thickness of the adjacent layer, that is, 40 μm in total, and the heat shrinkable multilayer films according to Example 22 and Comparative Example 7 each had 32 μm in thickness of the core layer, 4 μm in thickness of the adjacent layer, and 0.5 μm in thickness of the surface layer, that is, 41 μm in total.

TABLE 8

| | | Exam- | Exam- | Exam- | Exam- | Exam- | Exam- | Exam- | Com- | Com- | Com- |
|---|---|---|---|---|---|---|---|---|---|---|---|
| | | ple | ple | ple | ple | ple | ple | ple | parative | parative | parative |
| | | 16 | 17 | 18 | 19 | 20 | 21 | 22 | Example 5 | Example 6 | Example 7 |
| Core | Propylene copolymer | 50 | 60 | 70 | 76 | 74 | 60 | 50 | 65 | 45 | 65 |
| layer | Alicyclic petroleum | 35 | 30 | 25 | 21 | — | — | 35 | 35 | 35 | 35 |
| | resin | | | | | | | | | | |
| | Aromatic petroleum | — | — | — | — | 21 | 35 | — | — | — | — |
| | resin | | | | | | | | | | |
| | Long-chain branched | 15 | 10 | 5 | 3 | 5 | 5 | 15 | — | 20 | — |
| | polypropylene | | | | | | | | | | |
| Adjacent | Linear low-density | 30 | 30 | 10 | 30 | 30 | 30 | 30 | 30 | 30 | 30 |
| layer | polyethylene | | | | | | | | | | |
| | Cyclic olefin-based | 70 | 70 | 90 | 70 | 70 | 70 | 70 | 70 | 70 | 70 |
| | resin | | | | | | | | | | |
| Surface | Cyclic olefin-based | — | — | — | — | — | — | 100 | — | — | 100 |
| layer | resin | | | | | | | | | | |

The unit of each material constituting the surface layer, the adjacent layer, and the core layer is % by mass.

### 4-2. Evaluation

The following evaluations were performed for Examples 16 to 22 and Comparative Examples 5 to 7 described above.

### 4-2-1. Glossiness

Glossiness at an incident angle of 45° was measured for Examples 16 to 22 and Comparative Examples 5 to 7 using VG-2000 manufactured by Nippon Denshoku Industries Co., Ltd. by a method in accordance with ASTM D523.

### 4-2-2. Appearance Inspection

Presence or absence of an appearance defect was visually inspected. Unevenness like frosted glass could be visually confirmed, and those that could not be said to be transparent were determined to have an appearance defect, and unevenness could not be visually confirmed, and those that could be said to be transparent were determined to have no appearance defect.

### 4-2-3. Heat Shrinkage

Three measurement samples each having a size of 100 mm in length×100 mm in width (the TD direction of the film is defined as a longitudinal direction, and the MD direction is defined as a lateral direction) were cut out from arbitrary portions of each of the heat shrinkable multilayer films according to Examples 16 to 22 and Comparative Examples 5 to 7. Each measurement sample was immersed in hot water at 100° C. for 10 seconds, and then immersed in water at 20° ° C. for 10 seconds. Length L1 in the TD direction and length L2 in the MD direction of the measurement sample after being taken out of water were measured, the heat shrinkage in each direction was calculated according to the following formula, and the average value of the three samples was calculated.

Heat shrinkage (%)={(100−Ln)/100}×100(n=1,2)

### 4-2-4. Loosening Amount

Using the heat shrinkable multilayer films according to Examples 16 to 22 and Comparative Examples 5 to 7, the same experiment as the evaluation of the loosening amount in Experiment 2 was performed. For each heat shrinkable multilayer film, it was determined that loosening was suppressed when the measured displacement (loosening amount, mm) of the length of the cylindrical body with respect to the outer periphery of the container was 1.3 mm or less, and loosening occurred when the measured displacement is more than 1.3 mm.

### 4-3. Evaluation Results

The results of Experiment 4 are shown in Table 9.

TABLE 9

| | Exam- | Exam- | Exam- | Exam- | Exam- | Exam- | Exam- | Com- | Com- | Com- |
|---|---|---|---|---|---|---|---|---|---|---|
| | ple | ple | ple | ple | ple | ple | ple | parative | parative | parative |
| | 16 | 17 | 18 | 19 | 20 | 21 | 22 | Example 5 | Example 6 | Example 7 |
| Glossiness | 151.1 | 148.4 | 149.9 | 150.1 | 136.5 | 136.8 | 155.5 | 150.8 | 138.2 | 155.0 |
| Appearance defect | None | None | None | None | None | None | None | None | Present | None |
| Loosening amount | 0.8 | 0.7 | 0.8 | 0.8 | 0.8 | 0.8 | 0.7 | 1.5 | 0.8 | 1.4 |
| after heat shrinkage | | | | | | | | | | |
| Shrinkage (%) MD/TD | 19/74 | 14/70 | 15/71 | 14/68 | 13/67 | 18/73 | 19/73 | 19/74 | 12/62 | 19/73 |

According to the above results, in Examples 16 to 19 and 22, the shrinkage in the TD direction and the MD direction falls within the preferable ranges, and the loosening amount after heat shrinkage was preferably suppressed. In addition, the glossiness was relatively high, and there was no appearance defect. From the viewpoint of the shrinkage and the loosening amount after heat shrinkage, relatively preferable results were obtained also in Examples 20 and 21, but the glossiness decreased in these examples. This is considered to be because an aromatic petroleum resin was used instead of the alicyclic petroleum resin. In Comparative Example 5 and Comparative Example 7 containing no long-chain branched polypropylene, the loosening amount after heat shrinkage was large. As a result, it has been confirmed that the long-chain branched polypropylene suppresses the loosening amount after heat shrinkage. On the other hand, in Comparative Example 6, the heat shrinkage in the TD direction was lower than the lower limit of the preferable range, an appearance defect was confirmed, and the glossiness was also low. This is considered to be because a relatively large amount of 20% by mass of the long-chain branched polypropylene is contained.

### Experiment 5. Study of Olefin Film 1D

### 5-1. Preparation of Examples and Comparative Examples

As described below, heat shrinkable multilayer films according to Examples 23 to 31 and Comparative Examples 8 to 10 were prepared. Examples 23 to 31 and Comparative Examples 8 to 10 had a five-layer structure shown in FIG. 6A. These heat shrinkable multilayer films have a specific gravity of less than 1.

The components shown in Table 10 were used as raw materials constituting the core layer, the adjacent layer, and the surface layer, and these were mixed at the ratios shown in Table 10 to obtain raw material compositions constituting the core layer, the adjacent layer, and the surface layer according to Examples 23 to 31 and Comparative Examples 8 to 10. The raw materials of the core layer were common in Examples 23 to 31 and Comparative Examples 8 to 10, but the thickness of the core layer was different. APEL APL6509T (manufactured by Mitsui Chemicals, Inc.) was used as the cyclic olefin-based resin of the surface layer and the adjacent layer. Evolue SP1020 (manufactured by Prime Polymer Co., Ltd.) was used as the ethylene-based resin of the adjacent layer according to Examples 23 to 31 and Comparative Examples 8 to 10. On the other hand, no ethylene-based resin was used for the adjacent layer according to Example 31. ARKON P125 (manufactured by Arakawa Chemical Industries, Ltd.) was used as the petroleum resin of the adjacent layer and the core layer. The anti-blocking agent was common in Examples 23 to 31 and Comparative Examples 8 to 10.

Subsequently, the raw material compositions constituting the core layer, the adjacent layer, and the surface layer were melted using another extruder at a barrel temperature of 180° C. for the core layer, a barrel temperature of 210° C. for the adjacent layer, and a barrel temperature of 210° ° C. for the surface layer, extruded from a T-die, and cooled and solidified with a roll cooled to 30° ° C. to prepare an unstretched sheet. This unstretched sheet was stretched 1.3 times in the MD direction with a roll stretching machine, and then stretched 5 times in the TD direction with a tenter stretching machine at a temperature of 110° ° C. to prepare a heat shrinkable multilayer film having a thickness of 40 μm in which each layer had the thickness shown in Table 10. The “thickness (%) of surface layer with respect to total thickness” shown in Table 10 is the thickness (%) of the resin constituting one layer of the surface layer with respect to the thickness of the resin constituting the entire heat shrinkable multilayer film.

TABLE 10

| | | | | | | | | | | | Com- | Com- | Com- |
|---|---|---|---|---|---|---|---|---|---|---|---|---|---|
| | | Exam- | Exam- | Exam- | Exam- | Exam- | Exam- | Exam- | Exam- | Exam- | parative | parative | parative |
| | | ple | ple | ple | ple | ple | ple | ple | ple | ple | Exam- | Exam- | Exam- |
| | | 23 | 24 | 25 | 26 | 27 | 28 | 29 | 30 | 31 | ple 8 | ple 9 | ple 10 |
| Surface | Cyclic olefin-based | 100 | 100 | 100 | 100 | 70 | — | — | 100 | 100 | 100 | 100 | 100 |
| layer | resin | | | | | | | | | | | | |
| | Polyester resin | — | — | — | — | — | 100 | — | — | — | — | — | — |
| | Styrene resin | — | — | — | — | — | — | 100 | — | — | — | — | — |
| | Ethylene-based | — | — | — | — | — | — | — | — | — | — | — | — |
| | resin | | | | | | | | | | | | |
| | Anti-blocking | 0.1 | 0.1 | 0.1 | 0.1 | 0.1 | 0.1 | 0.1 | 0.1 | 0.1 | 0.1 | 0.1 | 0.1 |
| | agent | | | | | | | | | | | | |
| | Thickness (μm) | 0.5 | 3 | 0.5 | 0.5 | 0.5 | 0.5 | 0.5 | 0.5 | 0.5 | 0.5 | 0.5 | 5 |
| Adjacent | Cyclic olefin-based | 70 | 70 | 85 | 55 | 70 | 70 | 70 | 65 | 75 | 88 | 45 | 70 |
| layer | resin | | | | | | | | | | | | |
| | Ethylene-based | 10 | 10 | 10 | 10 | 10 | 10 | 10 | 25 | — | 10 | 10 | 10 |
| | resin | | | | | | | | | | | | |
| | Petroleum resin | 20 | 20 | 5 | 35 | 20 | 20 | 20 | 10 | 25 | 2 | 45 | 20 |
| | Thickness (μm) | 4.5 | 3.9 | 4.5 | 4.5 | 4.5 | 4.5 | 4.5 | 4.5 | 4.5 | 4.5 | 4.5 | 3.5 |
| Core | Propylene-based | 75 | 75 | 75 | 75 | 75 | 75 | 75 | 75 | 75 | 75 | 75 | 75 |
| layer | resin | | | | | | | | | | | | |
| | Petroleum resin | 25 | 25 | 25 | 25 | 25 | 25 | 25 | 25 | 25 | 25 | 25 | 25 |
| | Thickness (μm) | 30 | 26.2 | 30 | 30 | 30 | 30 | 30 | 30 | 30 | 30 | 30 | 23 |

| | | | | | | | | | | | | |
|---|---|---|---|---|---|---|---|---|---|---|---|---|
| Thickness (%) of | 1.25 | 7.5 | 1.25 | 1.25 | 1.25 | 1.25 | 1.25 | 1.25 | 1.25 | 1.25 | 1.25 | 12.5 |
| surface layer | | | | | | | | | | | | |
| with respect to | | | | | | | | | | | | |
| total thickness | | | | | | | | | | | | |

The unit of each material constituting the surface layer, the adjacent layer, and the core layer is % by mass. The unit of the anti-blocking agent is parts by mass.

### 5-2. Evaluation

The following evaluations were performed for Examples 23 to 31 and Comparative Examples 8 to 10.

### 5-2-1. Haze

Samples of the same size were cut out from the heat shrinkable multilayer films according to Examples 23 to 31 and Comparative Examples 8 and 10, and the haze (%) was measured according to JIS K7136.

### 5-2-2. Sebum Whitening Resistance

A mixed reagent containing 50% by mass of oleic acid, 40% by mass of stearyl palmitate, and 10% by mass of squalene as sebum equivalents was applied to both front and back surfaces of a sample cut out from the heat shrinkable multilayer film, and the sample was left at a temperature of 40° C. for 30 minutes. Thereafter, the haze (%) was measured according to JIS K7136, and compared with the haze before application of the mixed reagent. Samples having a small degree of increase from the haze before application of the mixed reagent were evaluated as level 1, level 2, and level 3 in order. That is, level 1 indicates having relatively high sebum whitening resistance, level 2 indicates having acceptable sebum whitening resistance, and level 3 indicates having sebum whitening resistance below the standard.

### 5-2-3. Heat Shrinkage

Three measurement samples each having a size of 100 mm in length×100 mm in width were cut out from arbitrary portions of each of the heat shrinkable multilayer films according to Examples 23 to 31 and Comparative Examples 8 to 10. For each sample, hot water at 70° ° C., 80° ° C., 90° C., and 98° C. was used to perform the same experiment as the evaluation of the heat shrinkage in Experiment 4, and the heat shrinkage was calculated according to the same formula as in Experiment 4.

### 5-2-4. Natural Shrinkage

Measurement samples having a size of 100 mm in length×100 mm in width (the TD direction of the film is defined as a longitudinal direction, and the MD direction is defined as a lateral direction) were cut out from arbitrary portions of each of the heat shrinkable multilayer films according to Examples 23 to 31 and Comparative Examples 8 to 10. These were allowed to stand in a low temperature thermostat (manufactured by IL-82 Yamato Scientific Co., Ltd.) adjusted to 40° C. for 7 days, and the natural shrinkage was calculated according to the formula in the same manner as the heat shrinkage.

### 5-2-5 Young's Modulus

For the heat shrinkable multilayer films according to Examples 23 to 31 and Comparative Examples 8 to 10, samples were cut out in the same manner as in the evaluation of Young's modulus in Experiment 1, and the Young's moduli (GPa) in the MD direction and the TD direction were each measured in the same procedure as in Experiment 1.

### 5-2-6. Tensile Elongation at Break (Toughness)

Measurement samples having a size of 40 mm in length×10 mm in width (the MD direction of the film is defined as a longitudinal direction, and the TD direction is defined as a lateral direction) were cut out from arbitrary portions of each of the heat shrinkable multilayer films according to Examples 23 to 31 and Comparative Examples 8 to 10. The measurement sample was set in Strograph (VE-ID manufactured by Toyo Seiki Seisaku-sho, Ltd.), and the tensile elongation at break was measured in accordance with JIS K-6732. The air temperature at the time of measurement was 5° C., and the tensile speed was 100 mm/min. The tensile elongation at break (toughness) was evaluated as “A” indicating that there was no problem in toughness when the elongation at break was 100% or more, and as “C” indicating that the toughness was out of the acceptable range when the elongation at break was less than 100%.

### 5-2-7. Blocking

For two samples cut out from arbitrary positions of each of the heat shrinkable multilayer films according to Examples 23 to 31 and Comparative Examples 8 to 10, the same experiment as the evaluation of blocking in Experiment 3 was performed. The blocking strength was evaluated as “A” when the blocking strength was 2000 g/cm or less, and as “B” when the blocking strength was more than 2000 g/cm.

### 5-2-8. Interlayer Adhesion Strength

Measurement samples having a size of 100 mm in length×10 mm in width (the TD direction of the film is defined as a longitudinal direction, and the MD direction is defined as a lateral direction) were cut out from arbitrary portions of each of the heat shrinkable multilayer films according to Examples 23 to 31 and Comparative Examples 8 to 10. The measurement sample was set in a peeling tester (Peeling TESTER HEIDON-17 manufactured by Shinto Scientific Co., Ltd.), and the strength (N/10 mm) at 23° C. when the sample was peeled off in the 180 degree direction at a tensile speed of 500 mm/min was measured. The interlayer adhesion strength was evaluated as “A” indicating that there was no problem in the interlayer adhesion strength when delamination occurred at the interface between the substrate and the intermediate layer (not occurred at the interface between the surface layer and the intermediate layer), and as “B” indicating that the interlayer adhesion strength was within the acceptable range in the case of 0.20 N/10 mm or more when delamination occurred at the interface between the surface layer and the intermediate layer.

### 5-3. Evaluation Results

The results of Experiment 5 are shown in Table 11.

TABLE 11

| | Exam- | Exam- | Exam- | Exam- | Exam- | Exam- | Exam- | Exam- | Exam- | Com- | Com- | Com- |
|---|---|---|---|---|---|---|---|---|---|---|---|---|
| | ple | ple | ple | ple | ple | ple | ple | ple | ple | parative | parative | parative |
| | 23 | 24 | 25 | 26 | 27 | 28 | 29 | 30 | 31 | Example 8 | Example 9 | Example 10 |
| Haze value | 3 | 3.3 | 3.2 | 3.5 | 4.2 | 3.1 | 3.1 | 4.1 | 2.8 | 2.9 | 2.9 | 3.4 |
| Sebum whitening | 1 | 2 | 2 | 1 | 1 | 1 | 1 | 1 | 2 | 3 | 1 | 3 |
| resistance level | | | | | | | | | | | | |
| Shrinkage in hot | 1/13 | 1/12 | 1/11 | 2/15 | 1/14 | 2/14 | 0/14 | 1/15 | 1/12 | 1/10 | 2/16 | 0/9 |
| water at 70° C. | | | | | | | | | | | | |
| (MD/TD) | | | | | | | | | | | | |
| Shrinkage in hot | 5/45 | 4/46 | 5/46 | 5/46 | 5/46 | 4/47 | 4/45 | 5/46 | 4/46 | 5/46 | 5/45 | 5/46 |
| water at 80° C. | | | | | | | | | | | | |
| (MD/TD) | | | | | | | | | | | | |
| Shrinkage in hot | 9/60 | 8/61 | 9/61 | 9/59 | 10/60 | 9/62 | 9/61 | 8/59 | 8/61 | 9/62 | 10/58 | 9/61 |
| water at 90° C. | | | | | | | | | | | | |
| (MD/TD) | | | | | | | | | | | | |
| Shrinkage in hot | 17/70 | 16/72 | 16/72 | 19/69 | 18/69 | 18/71 | 17/71 | 18/69 | 17/71 | 15/72 | 19/68 | 16/72 |
| water at 98° C. | | | | | | | | | | | | |
| (MD/TD) | | | | | | | | | | | | |
| Natural shrinkage | 0.4/2.8 | 0.3/2.6 | 0.3/2.4 | 0.4/3.0 | 0.4/2.9 | 0.4/2.8 | 0.4/2.9 | 0.4/3.0 | 0.3/2.6 | 0.3/2.3 | 0.4/3.2 | 0.2/2.2 |
| (MD/TD) | | | | | | | | | | | | |
| Young's modulus | 1.4/1.9 | 1.5/2.0 | 1.5/2.0 | 1.4/1.8 | 1.4/1.8 | 1.4/1.9 | 1.4/1.7 | 1.4/1.8 | 1.4/2.0 | 1.5/2.0 | 1.3/1.7 | 1.5/2.2 |
| (MD/TD) | | | | | | | | | | | | |
| Tensile elongation | A | A | A | A | A | A | A | A | A | A | C | A |
| at break | | | | | | | | | | | | |
| Blocking | A | A | A | A | A | A | A | A | A | A | A | A |
| Interlayer adhesion | A | A | A | A | A | B | B | A | A | A | A | A |
| strength | | | | | | | | | | | | |

According to the results in Table 11, in Examples 23 to 31, it has been confirmed that there is no manufacturing problem in the rigidity represented by the Young's modulus, and the films have sebum whitening resistance. According to Example 30, it has been confirmed that even when the content of the ethylene-based resin in the adjacent layer is relatively high, there is no problem in rigidity and sebum whitening resistance as in other Examples, and there is no manufacturing problem in other shrinkage, tensile elongation at break, blocking, and interlayer adhesion strength. Further, according to Example 31, it has been confirmed that there is no manufacturing problem in rigidity, sebum whitening resistance, shrinkage, tensile elongation at break, blocking, and interlayer adhesion strength even when the adjacent layer does not contain an ethylene-based resin. Meanwhile, in Comparative Example 8 in which the content of the petroleum resin in the intermediate layer was small, the sebum whitening resistance was poor. On the other hand, in Comparative Example 9 in which the content of the petroleum resin in the intermediate layer was large, the Young's modulus and the tensile elongation at break were poor, and a decrease in rigidity and toughness was confirmed. In Comparative Example 10, it is considered that the sebum whitening resistance was deteriorated due to the large ratio of the thickness of the surface layer.

The surface layers of Examples 28 and 29 do not contain a cyclic olefin-based resin. Therefore, it is considered that the interlayer adhesion strength between the surface layer and the adjacent layer was weaker than that in other examples although it was within an acceptable range.

### DESCRIPTION OF REFERENCE SIGNS

S1 to S5, S21 to S25, S31 to S35: Step
1A, 1B, 1C, 1D: Olefin film
2A, 2B, 2C, 2D: Adjacent layer
3A, 3B, 3C, 3D: Core layer
4B, 4C, 4D: Surface layer
5B: Fine particle
10B: Film
40B: Surface layer

1. A method for producing a resin film comprising:
preparing at least one of a film label having an ink layer and a resin layer, and a resin bottle to which the film label is attached as a starting material;
recovering a thermoplastic resin having a specific gravity of less than 1 from the starting material; and
extrusion molding a resin film having a specific gravity of less than 1 including the recovered thermoplastic resin in the raw material,
wherein the recovering a thermoplastic resin having a specific gravity of less than 1 comprises:
cutting the starting material or the resin layer into pieces;
separating the ink layer from the film label or pieces of the film label to obtain the resin layer or pieces of the resin layer from which the ink layer has been removed; and
subjecting the starting material, the resin layer, or the pieces thereof to specific gravity separation, and recovering the starting material, the resin layer, or the pieces thereof having a specific gravity of less than 1.

2. The method for producing a resin film according to claim 1, wherein the recovering a thermoplastic resin having a specific gravity of less than 1 comprises:
cutting the starting material into pieces;
separating the ink layer from pieces of the film label to obtain pieces of the resin layer from which the ink layer has been removed; and
subjecting the pieces of the resin layer to specific gravity separation, and recovering the pieces of the resin layer having a specific gravity of less than 1 in this order.

3. The method for producing the resin film according to claim 1, further comprising:
laminating an ink layer on the extrusion molded resin film to prepare a film label having an ink layer and a resin layer.

4. The method for producing a resin film according to claim 3, wherein the method further repeats one or more times recovery of a thermoplastic resin having a specific gravity of less than 1 using the prepared film label as the starting material, and preparation of a resin film having a specific gravity of less than 1 including the recovered thermoplastic resin in the raw material.

5. The method for producing the resin film according to claim 1, wherein the obtaining the resin layer or the pieces of the resin layer from which the ink layer has been removed comprises immersing the film label or the pieces of the film label in an alkaline aqueous solution to separate the ink layer.

6. The method for producing the resin film according to claim 5, further comprising:
neutralizing the resin layer or the pieces of the resin layer after being immersed in the alkaline aqueous solution.

7. The method for producing the resin film according to claim 1, wherein the obtaining the resin layer or the pieces of the resin layer from which the ink layer has been removed comprises immersing the film label or the pieces of the film label in water to separate the ink layer.

8. The method for producing the resin film according to claim 1, wherein the obtaining the resin layer or the pieces of the resin layer from which the ink layer has been removed comprises washing the resin layer or the pieces of the resin layer after the ink layer is separated.

9. The method for producing the resin film according to claim 1, further comprising:
drying the recovered thermoplastic resin having a specific gravity of less than 1 between the recovering a thermoplastic resin having a specific gravity of less than 1 and the extrusion molding a resin film having a specific gravity of less than 1.

10. The method for producing the resin film according to claim 2, further comprising:
laminating an ink layer on the extrusion molded resin film to prepare a film label having an ink layer and a resin layer.

11. The method for producing a resin film according to claim 10, wherein the method further repeats one or more times recovery of a thermoplastic resin having a specific gravity of less than 1 using the prepared film label as the starting material, and preparation of a resin film having a specific gravity of less than 1 including the recovered thermoplastic resin in the raw material.

12. The method for producing the resin film according to claim 2, wherein the obtaining the resin layer or the pieces of the resin layer from which the ink layer has been removed comprises immersing the film label or the pieces of the film label in an alkaline aqueous solution to separate the ink layer.

13. The method for producing the resin film according to claim 12, further comprising:
neutralizing the resin layer or the pieces of the resin layer after being immersed in the alkaline aqueous solution.

14. The method for producing the resin film according to claim 2, wherein the obtaining the resin layer or the pieces of the resin layer from which the ink layer has been removed comprises immersing the film label or the pieces of the film label in water to separate the ink layer.

15. The method for producing the resin film according to claim 2, wherein the obtaining the resin layer or the pieces of the resin layer from which the ink layer has been removed comprises washing the resin layer or the pieces of the resin layer after the ink layer is separated.

16. The method for producing the resin film according to claim 2, further comprising:
drying the recovered thermoplastic resin having a specific gravity of less than 1 between the recovering a thermoplastic resin having a specific gravity of less than 1 and the extrusion molding a resin film having a specific gravity of less than 1.

17. The method for producing the resin film according to claim 3, wherein the obtaining the resin layer or the pieces of the resin layer from which the ink layer has been removed comprises immersing the film label or the pieces of the film label in an alkaline aqueous solution to separate the ink layer.

18. The method for producing the resin film according to claim 17, further comprising:
neutralizing the resin layer or the pieces of the resin layer after being immersed in the alkaline aqueous solution.

19. The method for producing the resin film according to claim 17, wherein the obtaining the resin layer or the pieces of the resin layer from which the ink layer has been removed comprises immersing the film label or the pieces of the film label in water to separate the ink layer.

20. The method for producing the resin film according to claim 17, wherein the obtaining the resin layer or the pieces of the resin layer from which the ink layer has been removed comprises washing the resin layer or the pieces of the resin layer after the ink layer is separated.
